(19) United States
(12) Patent Application Publication
(10) Pub. No.: US 2022/0180266 A1
(43) Pub. Date: Jun. 9, 2022

(54) ATTRIBUTE-BASED SHIFT ALLOCATION

(71) Applicant: Leading Path Consulting, LLC, McLean, VA (US)

(72) Inventors: Christopher GUIFFRE, Charlottesville, VA (US); Mahmoud BELHAJ, Sterling, VA (US)

(73) Assignee: Leading Path Consulting, LLC, McLean, VA (US)

(21) Appl. No.: 17/457,795

(22) Filed: Dec. 6, 2021

Related U.S. Application Data
(60) Provisional application No. 63/122,088, filed on Dec. 7, 2020.

(51) Int. Cl. G06Q 10/06; G06Q 10/10; G06N 20/00

(52) U.S. Cl. CPC G06Q 10/06311; G06N 20/00; G06Q 10/06398; G06Q 10/1093

(57) ABSTRACT

Disclosed are methods and systems for attribute-based shift allocation. For example, shift owner profiles having first attributes and shifter profiles having second attributes may be generated for shift owners and shifters, respectively. In response to receiving an indication to initiate an opening of a shift associated with a shift owner, the shift may be opened. At least a portion of shift data defining the shift may be automatically generated based on the indication and/or first attributes of the shift owner. A subset of the shifter profiles may be identified that have respective one or more second attributes that at least partially match the shift data. The shift may be published to the subset and allocated to at least one shifter that selects the shift. Trained machine learning model(s) modifiable based on shift feedback may be used to improve profile generation, shift opening and generation, shift publishing, and shift selection.

### CROSS-REFERENCE TO RELATED APPLICATION

This application claims the benefit of U.S. Provisional Patent Application No. 63/122,088 filed on Dec. 7, 2020, which is incorporated by reference in its entirety herein.

### TECHNICAL FIELD

Various embodiments of the present disclosure relate generally to generating shifts based on known or determined attributes and matching the shifts with shift workers based on shift worker attributes.

### BACKGROUND

Traditional work blocks are generally segmented off in multiple hour chunks that are pre-planned for weeks, months, or years at a time. These traditional blocks require work to be completed during those multiple hour chunks whether or not the given work requires more or less time than the given multiple hour chunk. Often, when the work requires less time than the given multiple hour chunk, the entity paying for the work is at a loss due to the restriction of the multiple hour chunk. Often, when the work requires more time than the given multiple hour chunk, second or additional similar multiple hour chunks are reserved, resulting in inefficiencies.

Additionally, traditional work shifts prevent dynamic organization, booking, and formatting of shift work due to the limitations of existing shift management technology.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, methods and systems are disclosed for attribute-based generating and allocating of a shift opening. For example, shift owner profiles and shifter profiles may be generated for shift owners and shifters, respectively, where the shift owner profiles include at least a plurality of first attributes and the shifter profiles include at least a plurality of second attributes. In response to receiving an indication to initiate an opening of a shift associated with one of the shift owners, the shift may be opened. At least a portion of shift data defining the shift may be automatically generated based on the indication and/or one or more of the plurality of first attributes of the shift owner's profile. A subset of the plurality of shifter profiles may be identified that have respective one or more second attributes that at least partially match the shift data. In some examples, the subset may be identified, at least in part, using a trained machine learning model. The shift may be published to the subset. One or more additional trained machine learning models may also be implemented in the shift opening, shift generation, shifter identification, and shifter publishing processes. In response to receiving an acceptance of the shift from at least one shifter profile in the subset, the shift may be allocated to the shifter associated with the at least one shifter profile. Feedback associated with the shift may be received and used as a basis for modifying the machine learning model(s).

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment, according to one or more embodiments.

FIG. 2A depicts a flowchart for allocating a shift opening and improving the shift process based on feedback generated, according to one or more embodiments.

FIG. 2B depicts a flowchart for using one example machine learning model to perform at least a portion of a shift opening process, according to one or more embodiments.

FIG. 2C depicts a flowchart for using another example machine learning model to perform at least a portion of a shift opening process, according to one or more embodiments.

FIG. 2D depicts a flowchart for using a further example machine learning model to perform at least a portion of a shift opening process, according to one or more embodiments.

FIG. 2E depicts a flowchart for performing at least a portion of a shifter profile identification process, according to one or more embodiments.

FIG. 2F depicts a flowchart for using an example machine learning model to perform at least a portion of a shifter profile identification process, according to one or more embodiments.

FIG. 2G depicts a flowchart for using an example machine learning model to perform at least a portion of the publishing process, according to one or more embodiments.

FIG. 3 depicts a high-level conceptual diagram of the shift opening and allocation process, according to one or more embodiments.

FIG. 4A depicts an example user interface for managing shift owners and shifters, according to one or more embodiments.

FIG. 4B depicts an example user interface for onboarding a shifter, according to one or more embodiments.

FIG. 4C depicts an example user interface for onboarding a shift owner, according to one or more embodiments.

FIG. 4D depicts an example shifter profile, according to one or more embodiments.

FIG. 4E depicts an example quick shifter profile view provided via a user interface for managing shift owners and shifters, according to one or more embodiments.

FIG. 5A depicts an example shift scheduling user interface, according to one or more embodiments.

FIG. 5B depicts an example shift generation user interface, according to one or more embodiments.

FIG. 6 depicts a conceptual diagram that shows an example implementation of an onboarding process to enable attribute-based shift generation and selection, according to one or more embodiments.

FIG. 7 depicts a conceptual diagram that shows an example implementation of an attribute-based shift generation and selection process, according to one or more embodiments.

FIG. 8 depicts a conceptual diagram that shows another example implementation of the attribute-based shift generation and selection process, according to one or more embodiments.

FIG. 9 depicts an example gamification user interface, according to one or more embodiments.

FIG. 10 depicts an example data flow for training a machine learning model, according to one or more embodiments.

FIG. 11 depicts an example data flow for deploying a trained machine learning model, according to one or more embodiments.

FIG. 12 depicts an example of a computing device, according to one or more embodiments, according to one or more embodiments.

Like reference numbers and designations in the various drawings indicate like elements.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “computer system” generally encompasses any device or combination of devices, each device having at least one processor that executes instructions from a memory medium. Additionally, a computer system may be included as a part of another computer system.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In general, the present disclosure provides systems and methods for generating dynamic shifts utilizing shift owner attributes, providing the generated shifts to a plurality of shift workers based on one or more shifter attributes and in a probabilistic manner, and filling the generated shifts in an optimal manner.

As applied herein, machine learning is an application of artificial intelligence (AI) that provides systems the ability to automatically learn and improve from experience without being explicitly programmed. Machine learning can be generally referred to systems that can learn from experience. Machine learning applies both autonomy and adaptively when developing a machine learning model that can be used at a given time and that may be improved over time. Machine learning focuses on the development of computer programs that can access data and use it to learn for themselves. Artificial Neural Networks (ANN) refer to models of human neural networks that are designed to help computers learn. Natural Language Processing (NLP) refers to systems that can understand language.

As applied herein, statistical learning or a statistical learning theory is a framework for machine learning drawing from of statistics and functional analysis. Statistical learning deals with the problem of finding a predictive function based on data.

As applied herein, SOTA machine learning is a short state of the art learning for two kinds of neural network algorithms, Recurrent Neural Networks (RNN) and Long Short-Term Memory (LSTM).

As applied herein, augmented reality (AR) is an interactive experience of a real-world environment where the objects that reside in the real world are enhanced by computer-generated perceptual information, sometimes across multiple sensory modalities, including visual, auditory, haptic, somatosensory and olfactory.

As applied herein, geofencing is a technique of creating a virtual perimeter or boundary around a location which recognizes a user or user device (e.g., via a sensor such as a global positioning system (GPS) sensor) as it enters or remains within the boundary to perform a task based on the user's location information (e.g. serving smartphone users with ads that are relevant to them based on their location). For example, geofencing can be regarded as a mobile marketing optimization strategy.

As applied herein, gamification is the application of game-design elements and game principles in non-game contexts. It can also be defined as a set of activities and processes to solve problems by using or applying the characteristics of game elements, including outside of a given game (e.g., points for completing shifts successfully).

As applied herein, a location-based service (LBS) is a general term denoting software services which utilize geographic data and information to provide services or information to users. LBS can be used in a variety of contexts, such as health, indoor object search, entertainment, work, personal life, etc.

As applied herein, map services offer access to the contents of a map hosted on a server. Map services can expose different levels of capabilities. When a map service is hosted on ArcGIS Online or Portal for ArcGIS, it exposes a set of tiled images that are used by the client for rapid map navigation. When a map service is hosted on an ArcGIS Server site, it exposes additional functionality, such as dynamic drawing, query, and search. With ArcGIS Server, further web services may be available through the map service root URL that allow network analysis, vector feature editing, and so forth.

As applied herein, AI Tools (e.g., algorithms, datasets, etc.) include, but are not limited to, Supervised Learning, Unsupervised Learning, Semi-Supervised Learning, Self-Supervised Learning, Convolutional Neural Networks (CNN), Transformers, Recurrent Neural Networks (RNN), Seq2Seq, Long Short Term Memory (LSTM), Bayesian Inference, Generative Adversarial Networks (GAN), Deep Reinforcement Learning, or the like or a combination thereof.

As mentioned above, traditional work shifts prevent dynamic organization, booking, and formatting of shift work due to the limitations of existing shift management technology. Embodiments are disclosed herein to address the shortcomings of the existing shift management technology. For example, the systems described herein may be compatible with various types of existing scheduling tools utilized by institutions (e.g., companies) that have shift-based work to enable automated, attribute-based shift generation and publishing for large scale allocation of shifts.

Using existing shift management technology, a responsible party for generating and ensuring shifts are filled (e.g., a shift owner) may waste a significant amount of time and processing resources manually opening and populating shift data for each shift due to the number of inputs that may be received and processed, particularly when a large number of shifts (and often shifts of similar types) are being generated periodically. In contrast, in the embodiments disclosed herein, attributes may be attached to the shift owner, and these shift owner attributes may be used to automatically generate at least a portion of shift data defining the shift being generated. Accordingly, less inputs may be received, resulting in the technical benefit of reducing resources consumed to process and store such inputs (e.g., reduce processor use, storage use, memory use, etc.). Similarly, in the embodiments disclosed herein, attributes may also be attached to a party that fills the shift (e.g., a shifter), and these shifter attributes may be used in a matching process to identify a subset of shifters having attributes that at least partially match the shift data. The shift may be published to the identified subset of shifters for selection. These attributes may introduce a wider variety of factors utilized for shifter identification than existing shift management technology, leading to more efficient identification and ultimately allocation institution wide when a plurality of shifts within a same or similar time period are being generated and published. In some implementations, when identifying the subset of shifters to publish shifts to, geo-awareness, geofencing, and/or location based services (LBS) may be used to fine-tune location-based attributes that may be utilized in the matching process.

Further, in at least some implementations, the above-described automated shift generation and publishing may be facilitated by machine learning for adjusting shift-related data beyond traditional work blocks when generating shifts and identifying the most optimal shifters to publish shifts to. For example, various machine learning models trained based on historical shift data and known outcomes may be deployed to predict factors like shift demand, probability of shift acceptance, length of time to fill the shift, probability that a given shifter will select the shift, and probability that a given shifter will not appear for the shift, among other examples. Predicted output of the machine learning models may be used to determine adjustments to the shift-related data for automatic implementation or provision as recommendation to better meet the demand, increase appeal of the shift, and/or optimize shifter utilization, for example. Feedback associated with the shift may then be utilized to modify, adjust, and/or retrain the machine learning models to improve accuracy of the models.

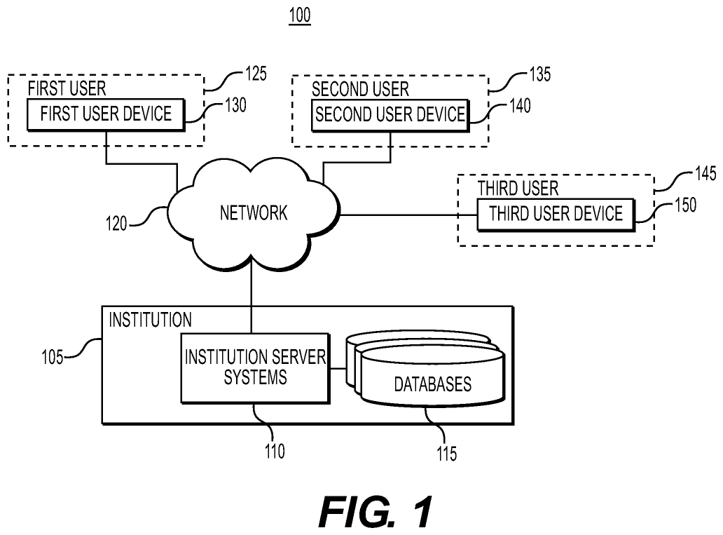

FIG. 1 depicts an exemplary environment of a system 100 for generating and allocating shifts associated with a first user 125 (e.g., a shift owner) for fulfillment by a second user 135 (e.g., a shifter that accepts the shift), according to one or more embodiments of the present disclosure. As shown in FIG. 1, system 100 may include an institution 105 (e.g., a company with a plurality of jobs) having one or more institution server systems 110 (e.g., company server systems) and one or more databases 115. Institution server systems 110 may include computing systems. As such, institution server systems 110 may each include one or more processors and a memory for storing and executing applications or software modules of system 100. For example, institution server systems 110 may include one or more software modules to communicate with user devices 130, 140, 150 through a network 120, such as the Internet. Further, the one or more processors may be configured to access the memory and execute processor-readable instructions, which when executed by the processor configures the processor to perform a plurality of functions of system 100 for filling shifts associated with (e.g., originated by) first user 125 and filled by the second user 135. Such functions may also include the onboarding of users, such as first user 125 and second user 135, to attach attributes to each user for use in the shift origination and filling process. In some examples, a third user 145 (e.g., a cloud manager associated with the institution) may facilitate onboarding of one or more users, among other management tasks.

Databases 115 may store shift information, personal information, algorithms, machine learning code, shifter data, shift owner data, or the like. Institution server systems 110 may be in communication with databases 115 such that institution server systems 110 may access, identify, and retrieve any subset of shift, shifter, shift owner or related information from databases 115, as detailed further below. Institution 105 may be any entity that has a need to fill multiple shifts across one or more locations and may include, but is not limited to, institutions in the hospitality industry, care industry, construction industry, landscaping industry, travel industry, warehousing industry, shipping industry, consumer goods industry, transportation industry, janitorial industry, service industry, or the like.

Although FIG. 1 shows institution server systems 110 and databases 115 as associated with institution 105, it will be understood that one or more of institution server systems 110 and/or databases 115 may be based at a third party location, be controlled by a third party, or the like. For example, the systems and methods disclosed herein may be implemented by a third party configured to receive institutional information and to receive communication from the institution (e.g., via third user 145) to onboard users, as well as to receive communication from the institution (e.g., via first user 125) to generate shifts and to facilitate communication with a shifter (e.g., second user 135) to fill the shift. It will also be understood that a third party may be configured to coordinate shifts and shifters such that one or more shifters may be made available to multiple institutions. For example, as further disclosed herein, one or more shifters may be provided open shifts for selection from two or more different institutions such that the shifters may fulfill shifts corresponding to two or more institutions in a given period of time.

Users, such as first user 125 (e.g., shift owner), second user 135 (e.g., shifter), and third user (e.g., cloud manager) may communicate with institution server systems 110 through user devices, such as a first user device 130, a second user device 140, and a third user device 150, respectively. First user 125 may include an employee or manager of institution 105. In an exemplary embodiment, institution 105 may include a hospitality company and first user 125 may include a shift manager charged with filling shifts at one or more institution 105 properties.

Second user 135 may include a hospitality service provider, a transportation provider, a warehouse worker, a janitorial worker, a professional, a health care provider, a service provider, a construction worker, a task provider, a teacher, a caregiver, a landscaper, a security provider, a management provider, or any other individual or group of individuals that may fill a shift initiated by, managed by, or otherwise facilitated by first user 125 for institution 105. For example, second user 135 may be a hospitality service provider and may be qualified to provide housekeeping services for institution 105. Second user 135 may be presented a shift associated with or originated by first user 125. The shift may be one that second user 135 is qualified to perform, is physically in an area to be able to perform, and one that second user 135 elects to perform.

In some examples, third user 145 may include another employee or manager of institution 105. Alternatively, third user 145 may be associated with a third party providing services to institution 105. Continuing the example where institution 105 may include a hospitality company, third user 145 may be a cloud manager responsible for managing shift owners and shifters for a particular region (e.g., an Eastern region of the United States). Region management may include onboarding new shift owners and shifters within the region, removing shift owners and shifters who are no longer affiliated with the institution, and the like.

First user device 130, second user device 140, and third user device 150 may communicate with institution server systems 110 through network 120. First user device 130 may include a computing system or device, including a mobile device. First user device 130 may include one or more processors and a memory for downloading, installing, and running applications, including mobile applications. First user device 130 may include a first user application provided by institution 105 or a third party related to or separate and apart from institution 105, via institution server systems 110. The first user application may include, for example, one or more software modules for communicating with institution server systems 110 through network 120. The first user application may further include one or more software modules that enables first user 125 to generate a shift using first user device 130. The first user application may apply first user 125's data, past interactions, current events, and the like to pre-generate all or a portion of the shift. The first user application may also include one or more software modules that enables first user 125 to edit and/or update a shift owner profile generated for first user 125 through the onboarding process.

Second user device 140 may be a computing system or device, including a mobile computing device. As such, second user device 140 may include one or more processors and a memory for downloading, installing, and running applications or software modules. Second user device 140 may further be in communication with one or more transaction vehicles, or encoded information readers, such as a magnetic card reading device, a radio-frequency identification (RFID) reading device, a near-field communication (NFC) reading device, a bar code reading device, or the like. For example, second user device 140 may be used by second user 135 to select a shift and also to check into the shift, to record time associated with the shift, receive training associated with the shift, receive instructions associated with the shift, capture images related to the shift, or the like. It is understood that the one or more transaction vehicles may encompass a single device, such that the magnetic card reading device, RFID reading device, NFC reading device, and bar code reading device are a part of a single device.

Second user device 140 may include an application, such as a second user application provided by institution 105 or a third party related to or separate and apart from institution 105, via institution server systems 110. The second user application may include, for example, one or more software modules for receiving one or more shifts that second user 135 is qualified for, available for, and may be able to geographically reach. The second user application may provide alerts and may provide one or more shifts in an order or manner optimized for second user 135 via second user device 140. The second user application may also enable second user 135 to edit and/or update a shifter profile generated for second user 135 through the onboarding process.

Third user device 150 may be a computing system or device, including a mobile device. As such, third user device 150 may include one or more processors and a memory for downloading, installing, and running applications. Third user device 150 may include a third user application provided by institution 105 or a third party related to or separate and apart from institution 105, via institution server systems 110. The third user application may include, for example, one or more software modules for communicating with institution server systems 110 through network 120. The third user application may further include one or more software modules that enables third user 145 to manage shift owners and shifters, and the profiles thereof, within a particular region, through third device 150. The management may include onboarding the shift owners and shifters, such as first user 125 and second user 135, respectively. To onboard, the third user application may retrieve data associated with first user 125 and second user 135 from the institution server systems 110 or databases 115 to attach attributes to the users via profiles generated for the users. These attributes may be utilized in the shift generation and filling processes.

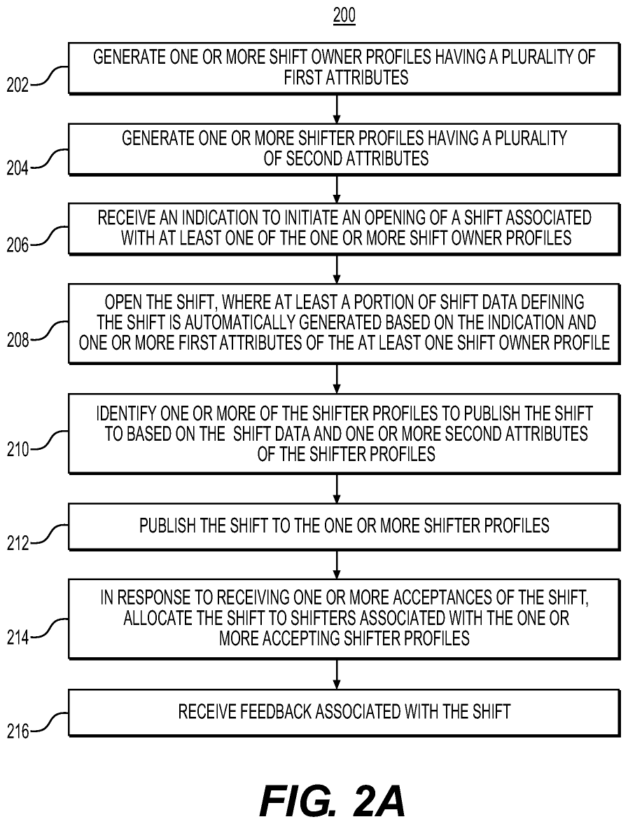

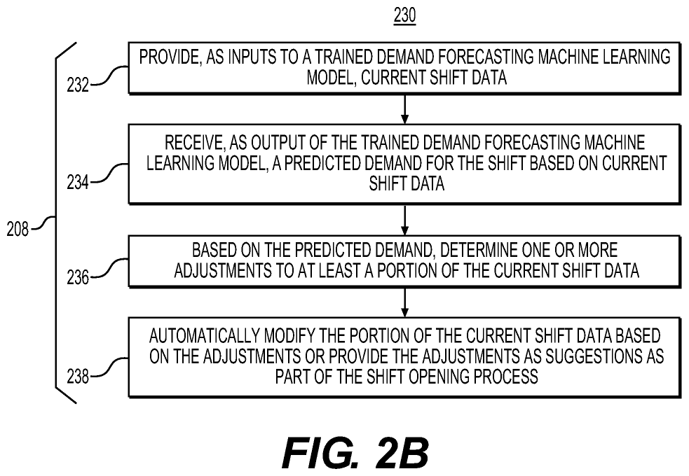

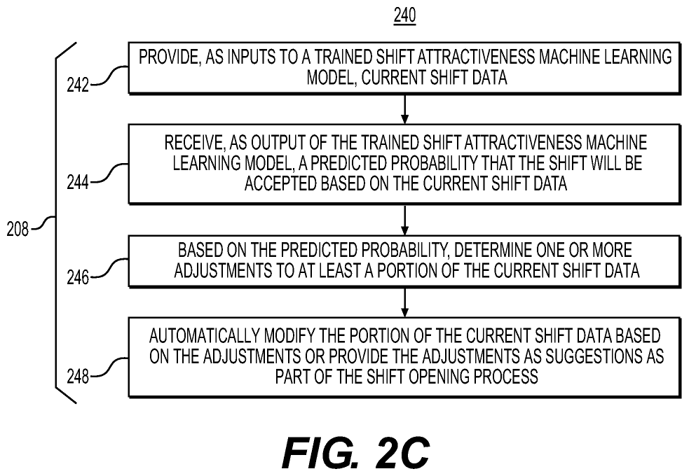

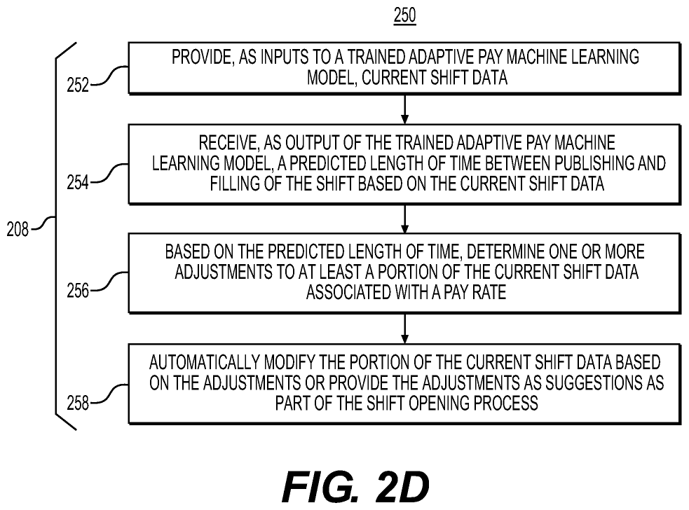

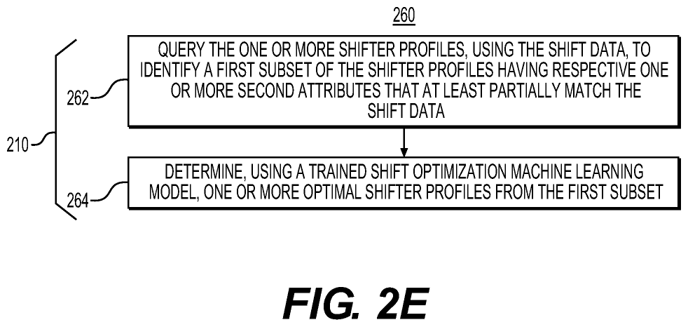

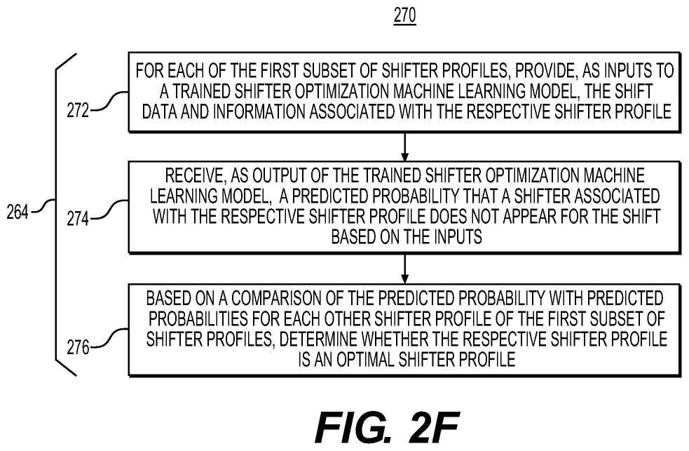

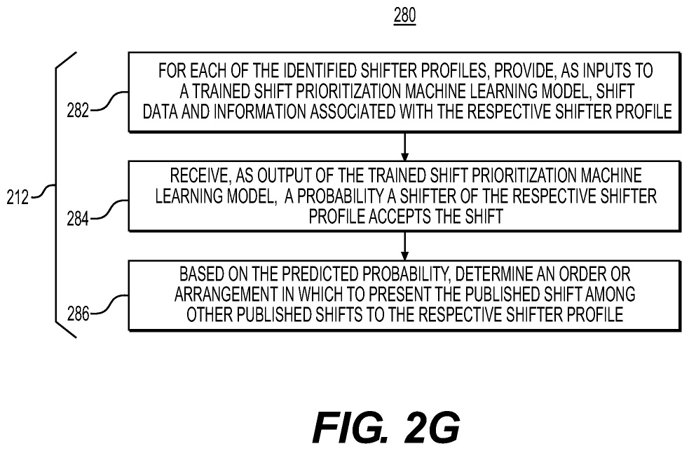

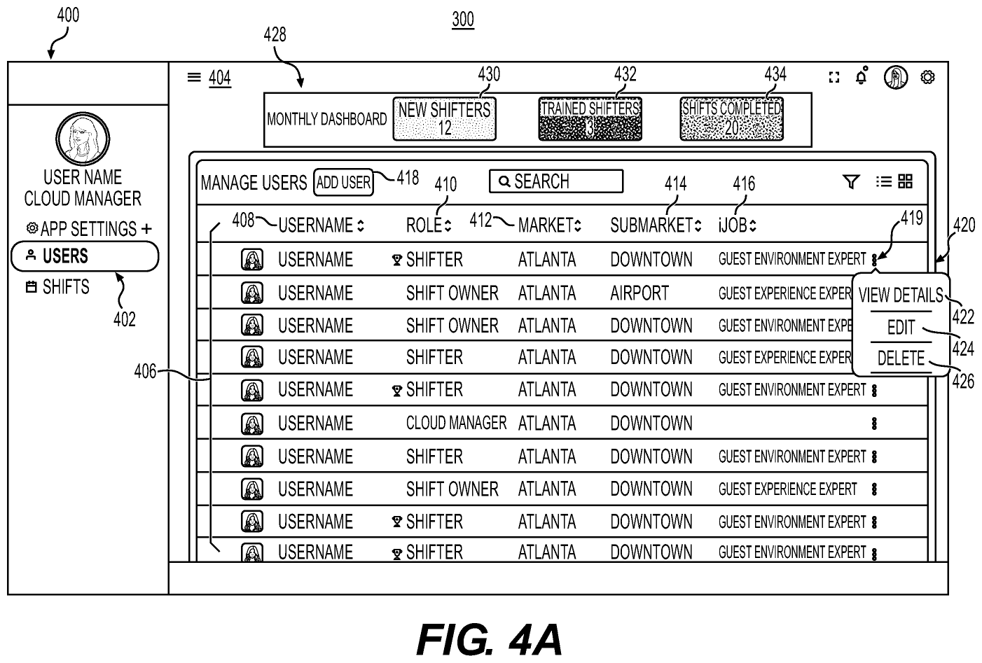

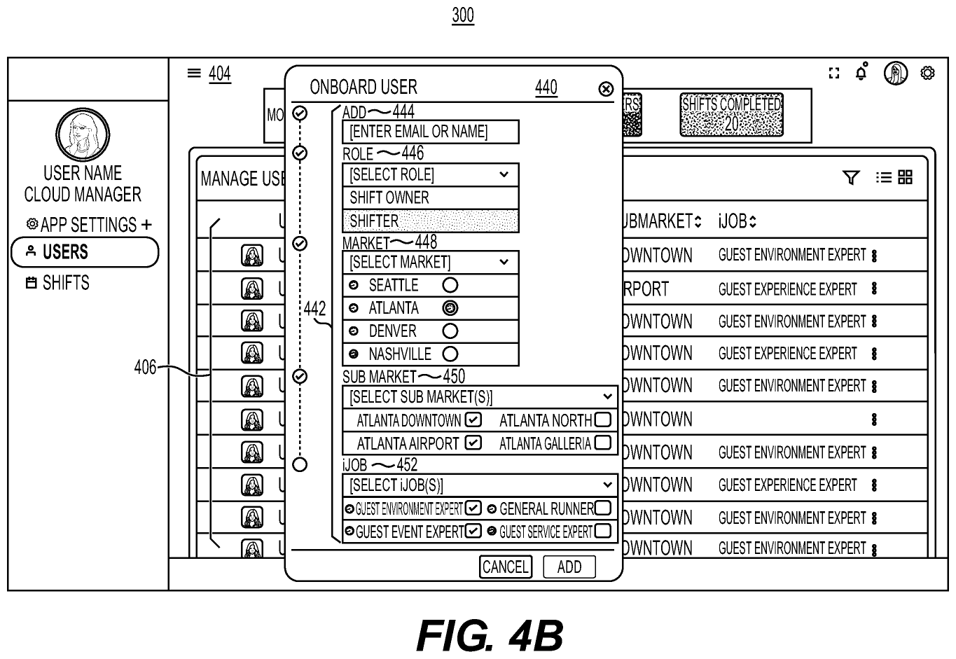

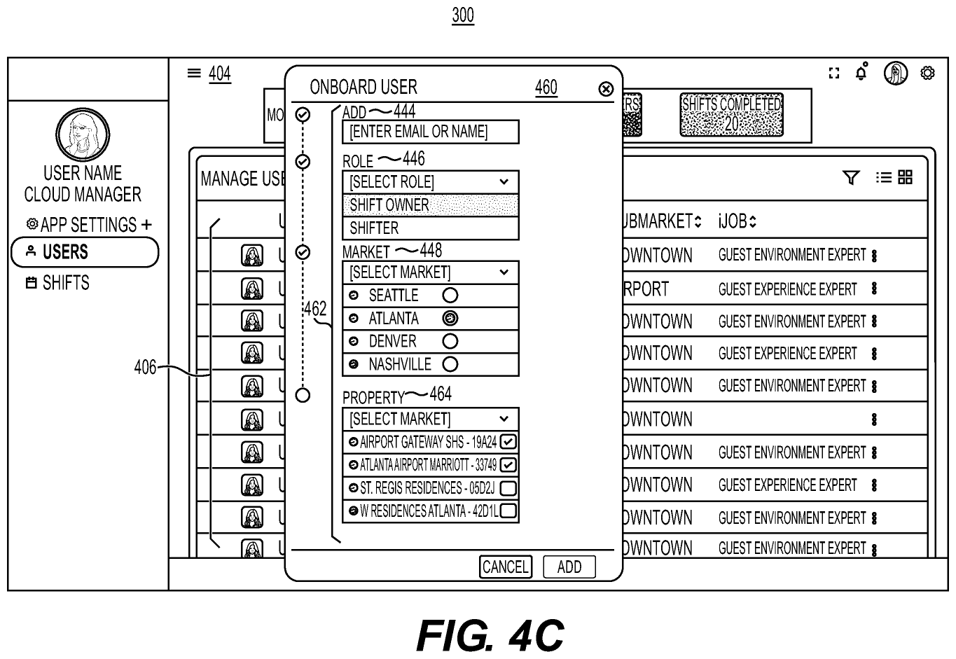

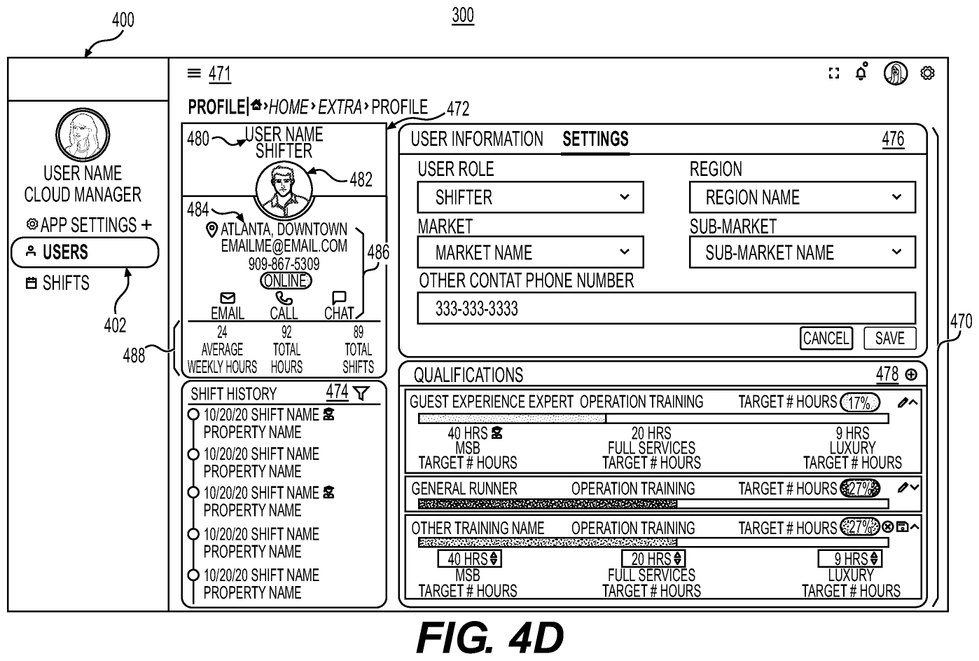

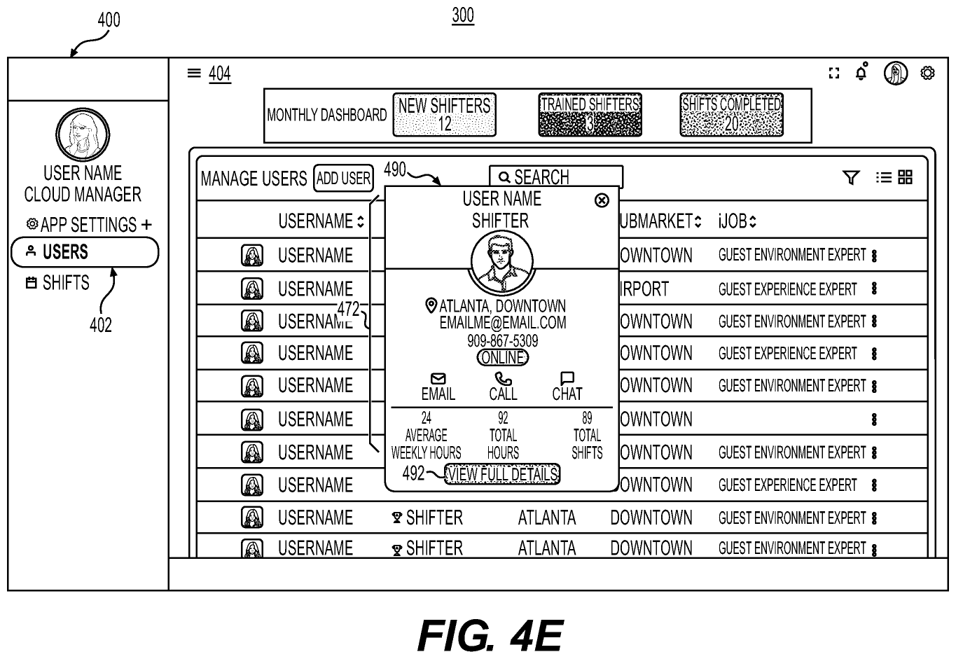

FIG. 2A depicts a flowchart of an exemplary process 200 for allocating a shift opening and improving the shift process based on feedback generated. At 202 of FIG. 2A, one or more shift owner profiles may be generated. The shift owner profile may be generated for a manager, supervisor, employee, or contractor of institution 105 who is able to generate shifts for one or more shifters to fill. A shift owner profile for a shift owner may include a plurality of first attributes associated with the shift owner. The shift owner profile may be generated at least partially by a cloud manager (e.g., third user 145) and/or the shift owner, as discussed in more detail with reference to FIGS. 4B and 4C. The first attributes may include one or more of shift owner information, shift owner applicable location, shift owner preference, a preferred shifter, shift type specific content, a graphical user interface (GUI) preference, or a shift owner historical information, among other information.

At 204, one or more shifter profiles may be generated. A shifter may be any individual or group of individuals that are able to fill one or more shifts (e.g., scheduled periods of time for performing work or other duties initiated by a shift owner). A shifter profile for a shifter may include a plurality of second attributes associated with the shifter. The shifter profile may be generated at least partially by the cloud manager (e.g., third user 145) and/or the shifter, as discussed in more detail with reference to FIGS. 4B and 4C. The second attributes may include one or more of shifter information, shifter qualifications, shifter position, shifter job title, shifter applicable location, shift preferences, hours, distance from key locations, co-worker preferences, manager preferences, preferred shift owner, shift type preferences, or GUI arrangement preferences.

At 206, an indication to initiate an opening of a shift associated with at least one of the one or more shift owner profiles generated at 202 may be received. In some examples, the indication may be received based on a shift owner actuating the generation of a new shift, updating a previous shift, copying a previous shift to generate a new shift (e.g., using a template), or the like. The indication may be any applicable manner in which a shift owner may initiate a shift opening such as via an application, application portal, a calendar, a scheduling GUI, or the like.

In other examples, the indication may be received based on a detected call-out by a shifter who had previously accepted a shift that now must be re-opened and re-filled. In further examples, the indication may be received based on a detected number of requests for a shift being above a predefine threshold. In yet further examples, the indication may be received based on data received from a demand forecasting model that indicates that there is a high demand (e.g., a demand exceeding a threshold) for shifts of certain types and/or at certain times within a next predefined period of time (e.g., within the next week, month, etc.). The demand forecasting model may be a machine learning model that may receive, as inputs, one or more of shift histories, shift owner attributes, past call-outs, shifter history, shift demand, shift likelihood of being filled, or the like. The forecasting model may output an indication to generate the shift at 206.

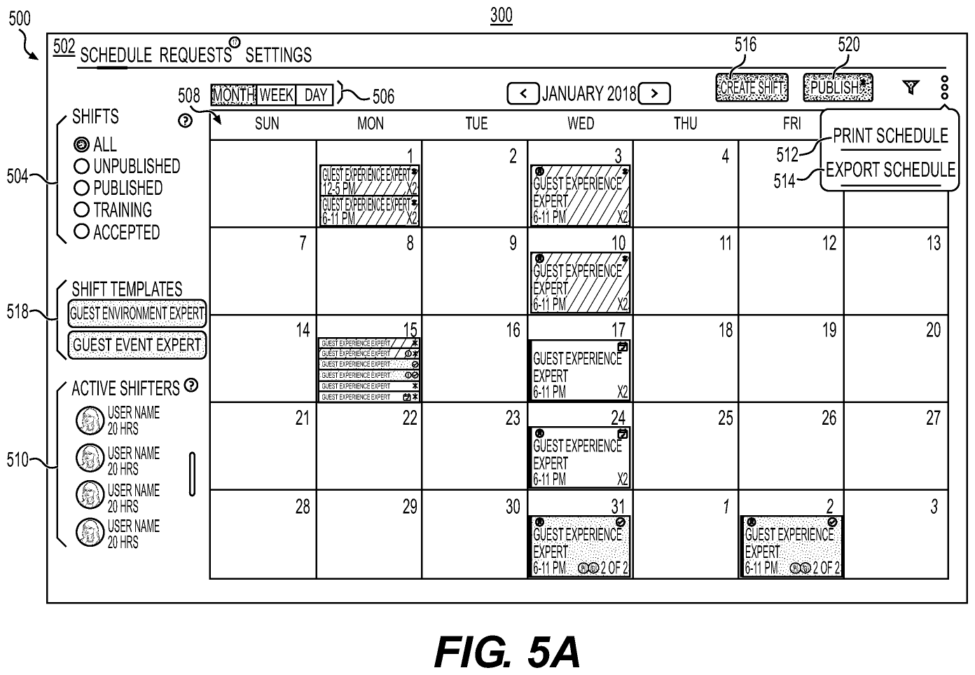

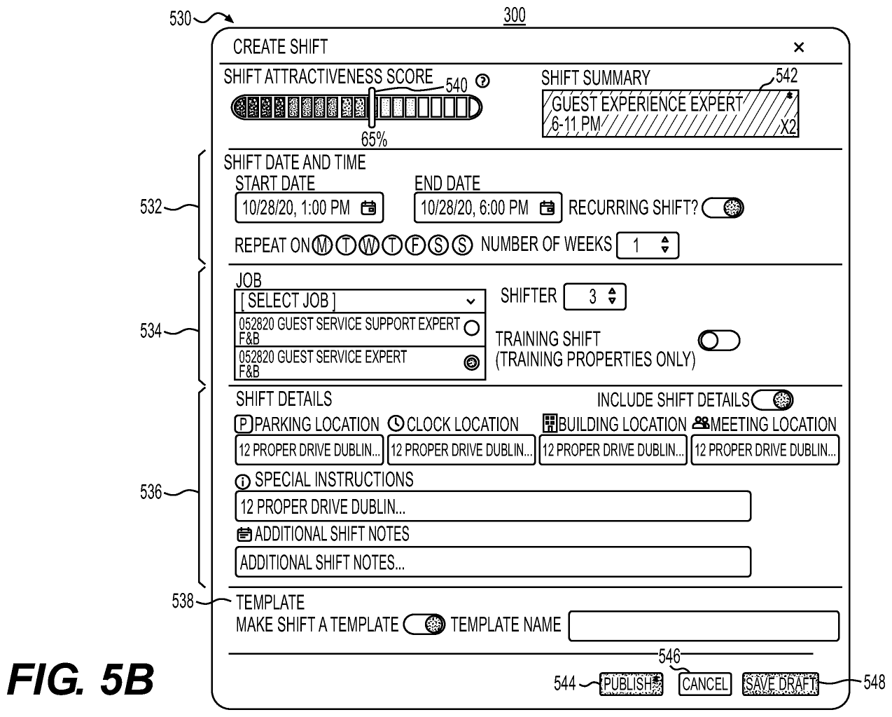

In response to receiving the indication, the shift may be opened (e.g., generated) at 208. The shift may be defined by shift data describing various aspects of the shift, including temporal aspects, job aspects, and other details or special instructions. When opened, at least a portion of the shift data defining the shift may be automatically generated based on the indication and/or one or more first attributes of the at least one shift owner profile of the shift owner that is associated with the opening or generating of the shift. According to an implementation, a user interface provided to a shift owner for generating the shift, such as a shift generation user interface as shown in FIG. 5B, may be dynamically modified based on the auto-generation process (e.g., data fields may be automatically populated) and, in certain instances, only relevant information may be provided enabling faster loading times, less memory use, and less graphical processing use to generate the shift. Additionally, the user interface may be tailored based on the shift owner's previous generation of shifts, based on the shift owner's preferences, and based on current events (e.g., upcoming holiday, one or more call-outs, ebbs and flows in workforce, etc.). For example, a machine learning model may receive previous shifts, shift owner preferences, and/or current as inputs and may output auto-generated data fields at 208. The machine learning model that outputs the auto-generated data fields may be a different machine learning model (e.g., trained using different training data, based on different algorithm(s), etc.) than the machine learning model that outputs the indication to generate the shift at 206.

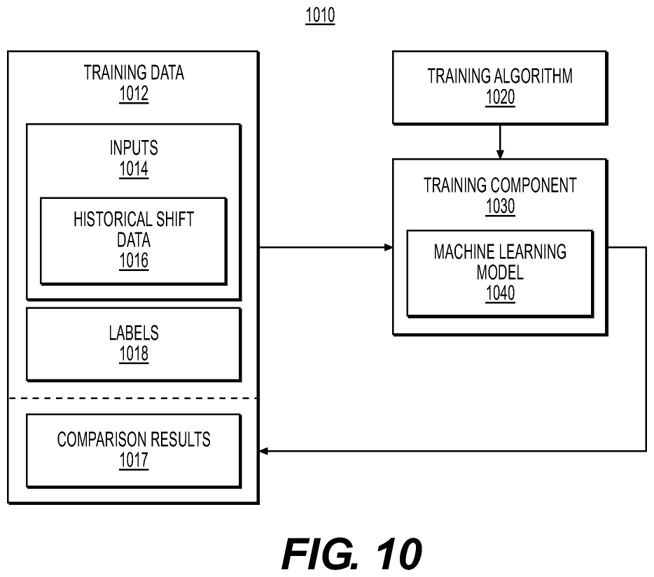

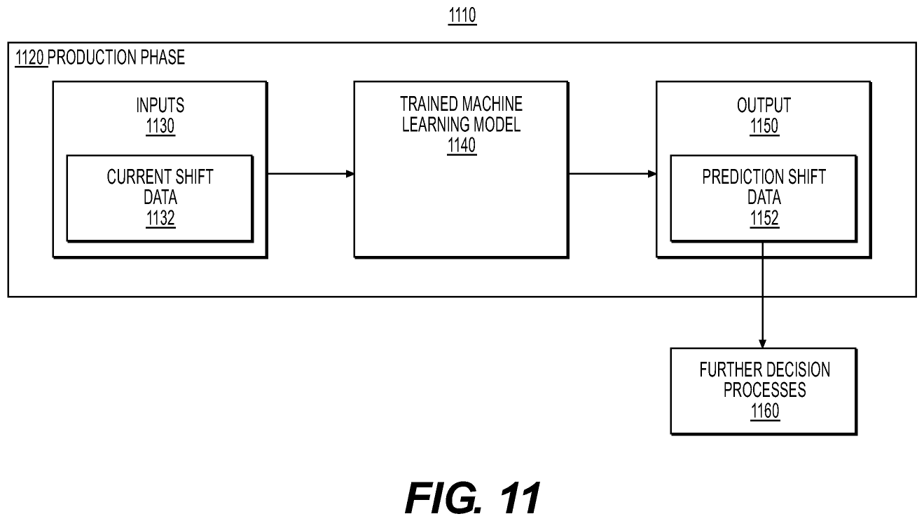

In some examples, at least a minimum amount of shift data required for opening a shift may be automatically generated. Additionally, some of the automatically generated shift data may be influenced or modified based on outputs from one or more trained machine learning models. As described in more detail with reference to FIGS. 10 and 11, the machine learning models may be trained based on historical shift data (e.g., shift data for previous shifts) and known outcomes associated with those shifts such as successful fulfillment of shifts, call-outs, timing of shifts, qualifications associated with shifts, locations, chronic nature of a shift, etc. The specific types of historical shift data and known outcomes provided as inputs for training may be dependent on the particular machine learning model (e.g., based on the purpose/goal of the particular machine learning model).

According to an implementation, the machine learning model techniques applied as part of the shift opening process may include forecasting demand for jobs, specializations, shift days/times, shift length and work locations to identify shift needs and optimize recruitment, staffing levels and training priorities to meet demand. The demand may be output by a demand forecasting machine learning model, for example, as described below in FIG. 2B. Additionally, machine learning model techniques to identify performance optimizers and/or incentives, including pay incentives, may be implemented as part of the shift opening process. Ensuring shifters are motivated and/or incented to pick up as many shifts as possible to maximize their part-time or full-time utilization requirements may be beneficial. For example, it may be more cost effective to have one part-time shifter work an average of 29 hours per week (maintaining his or her part-time status) than 3 shifters working an average of 10 hours per week, which results in triple the hiring, training and administrative costs. Accordingly, the system may be configured to provide insights and ability to optimize key performance levers such as maximizing a shifter's part-time and full-time average weekly hours as well as reducing call-offs/no-shows/late shows and increasing the likelihood call-offs will be picked up by other shifters despite how short of a notice is given. These improvements may be implemented through making shifts more attractive in terms of day, time and length or by increasing the number of posted shift and/or though pay incentives for shifters to pick up additional or specific shifts. The improvements may be made based on suggestions output by a machine learning model, such as a shift attractiveness machine learning model and/or an adaptive pay machine learning model described below in FIGS. 2C and 2D, respectively. The improvements may provide optimized utilization, reduced call offs, increased call off shift pick up, decreased no shows, or the like.

FIG. 2B depicts a flowchart of an exemplary process 230 for using the demand forecasting machine learning model to perform at least a portion of the shift opening process at 208 of FIG. 2A. For example, at 232, current shift data may be provided as inputs to the demand forecasting machine learning model. At 234, a predicted demand for the shift being generated (e.g., an upcoming shift) based on the current shift data may be provided as output. At 236, based on the predicted demand, adjustments to at least a portion of the current shift data that may cause the shift to more effectively meet the predicted demand may be determined. For example, extending or shortening shift length, adding an additional number of shifters, limiting or expanding job functions, etc. At 238, the adjustments may be implemented automatically to modify the portion of the current shift data based on the adjustments or the adjustments may be provided as recommendations or suggestions to the shift owner.

FIG. 2C depicts a flowchart of an exemplary process 240 for using the shift attractiveness machine learning model to perform at least a portion of the shift opening process at 208 of FIG. 2A. For example, at 242, current shift data may be provided as inputs to the shift attractiveness machine learning model. At 244, a predicted probability that the shift will be accepted based on the current shift data may be received as output from the shift attractiveness machine learning model. In some examples, the probability (e.g., a percentage) may be visually displayed as a shift attractiveness score to the shift owner during the shift generation process, as shown in FIG. 5B. At 246, based on the predicted probability, adjustments to at least a portion of the current shift data that will increase the probability may be determined. At 248, the adjustments may be implemented automatically to modify the portion of the current shift data based on the adjustments or the adjustments may be provided as recommendations or suggestions to the shift owner. The recommendations may include an updated shift attractiveness score reflecting an updated probability output by the model given the adjusted shift data.

Therefore, utilizing the shift attractiveness machine learning model, the system and techniques disclosed herein may assist shift owners that have trouble filling shifts because the day, time and length, among other example data, of one or more given shifts are not appealing. As one specific but non-limiting example, shifters working another full-time job for another institution (e.g., Monday-Friday (M-F) 8:00 AM-5:00 PM) may not want to or may not be able to pick up a shift (e.g., from 5:30 PM-12:00 AM) but may eagerly pick up a different shift (e.g., from 6:00 PM-11:00 PM). The system may show shift owners a probability that a given shift initiated by the shift owner will be picked up for a given day, time and shift length. For example, a percentage of the probability of the given shift being picked up based on the given day, time and shift length may be visually displayed to the respective shift owner, along with suggestions on how to adjust the shift to make it more attractive (e.g., modified timings for the shift, modified qualifications, alternative shift days, length of shift, etc.) and the predicted adjusted probability (e.g., percentage) that that the shift would be picked up if one or more of the suggestions were to be implemented.

Additionally, probabilities and likelihoods for different variables effecting shift uptake may be identified. For example, it may be determined (e.g., by a machine learning model disclosed herein) that the largest factor in predicting the likelihood of a first shifter taking a weekday shift is which other shifters take that same shift, the weather on the day a shift is published, prior shift experience rating, or the like. Any applicable technique for identifying feature importance may be applied (e.g., a correlation matrix). For example, permutation importance, which evaluates loss in accuracy for each feature as that feature is permuted while holding all other features constant, may be used.

FIG. 2D depicts a flowchart of an exemplary process 250 for using the adaptive pay machine learning model to perform at least a portion of the shift opening process at 208 of FIG. 2A. Based on an understanding that some shifts (e.g., day, time, length, etc.) jobs, and locations may be more difficult to fill than others, the adaptive pay machine learning model may be implemented to increase desirability/uptake of shifts and may normalize the amount made for more desirable shifts compared to less desirable shifts. For example, at 252, current shift data may be provided as inputs to the adaptive pay machine learning model. At 254, a predicted length of time between publishing and filling of the shift based on the current shift data may be received as output of the adaptive pay machine learning model. Based on the predicted length of time (e.g., if the length of time exceeds a predefined threshold), adjustments to at least a portion of the current shift data associated with a pay rate may be determined to decrease the length of time at 256. In some examples, the predefined threshold may be dependent on temporal aspects (e.g., if the shift is to start within a short time window of generation/publishing) or need (e.g., in an all hands on deck scenario) associated with the shift. At 258, the adjustments may be implemented automatically to modify the portion of the current shift data based on the adjustments or the adjustments may be provided as recommendations or suggestions to the shift owner to prompt the shift owner to increase shift uptake (e.g. by adjusting the wage rate or pay, real-time, for the shift). In some examples, an interface may be used to show shift owner's the probability a shift will be picked up based on the recommended adjustments.

Returning to FIG. 2A, once the shift is opened (e.g., at least the minimum shift data is generated), at 210, one or more of the shifter profiles generated at 204 may be identified for publishing the shift to, based on the shift data and one or more second attributes of the shifter profiles. FIG. 2E depicts a flowchart of an exemplary process 260 to perform at least a portion of the shifter profile identification process at 210 of FIG. 2A. For example, at 262, the shifter profiles may be queried, using the shift data, to identify an initial subset of the shifter profiles having one or more second attributes that at least partially match the shift data. In other words, attribute matching may be performed, where the first subset of the shifter profiles may meet a minimum matching criteria with the shift data.

As one example, location may be one factor included in the minimum matching criteria. That is, the initial subset of shifter profiles may include only shifters that are qualified to or able to work within a location perimeter associated with the shift. For example, a shifter in the state of Pennsylvania would not meet a minimum matching criteria for a shift designated for the state of Georgia. However, a shifter that is based in Georgia but currently located in the state of Nevada (e.g., on a project or on vacation) may receive the Georgia based shift based on the shifter being based in Georgia. According to an implementation, a calculation may be made that a given shifter in a first location may be able to travel to a second location based on one or more factors. For example, a shifter in North Carolina may receive the shift published in Georgia based on distance between the shifter's location in the state of North Carolina being within a threshold distance from the location associated with the shift in Georgia. Additionally, a shifter's profile may include scheduled travel such that a shifter based in Arizona that calendars a trip to Georgia may see the published shift in Georgia if the shift date and the travel date overlap.

The initial subset of shifter profiles may be further refined using machine learning techniques. For example, at 264, a subsequent subset of optimal shifter profiles may be determined from the initial subset of shifter profiles using a machine learning model, such as a shifter optimization machine learning model. FIG. 2F depicts a flowchart of an exemplary process 270 for using a trained shifter optimization machine learning model to perform at least a portion of the optimal shifter determination process at 264 of FIG. 2E. For example, at 272, for each of the initial subset of shifter profiles, the shift data and information associated with the respective shifter profile may be provided as inputs to the trained shifter optimization machine learning model. At 274, a predicted probability that a shifter associated with the respective shifter profile does not appear for the shift (e.g., the shifter call-outs or otherwise does not show up for the shift) may be provided as output of the trained shifter optimization machine learning model. At 276, based on a comparison of the predicted probability with predicted probabilities for each other shifter profile of the initial subset, a determination is made as to whether the respective shifter profile is an optimal shifter profile. For example, the respective shifter profile may be an optimal shifter profile if the predicted probability exceeds a predefined threshold. In some examples, the predefined threshold may be dynamic based on a number of shifter profiles in the first subset or a number of shifters needed to fill the shift, among other similar information.

One or more other factors may be used to identify the shifter profiles to publish the shift to. These factors include, but are not limited to, minimum shift requirements, security level required for the shift, training required, job specializations, certification required, hours required, shifter ranking, shifter rating, previously completed shifts by the shifter, evaluations based on previous shifts, duration of time between shifts, or the like. Additionally, in some examples, the shift is one of a plurality of shifts being opened within a predefined time frame, where the shifter profiles to publish the shift to are identified in view of the plurality of shifts (e.g., the shift may not be published a shifter although optimal for this shift given that they are also optimal for another shift for which there is more demand or less available shifters).

Returning to FIG. 2A, at 212 the shift may be published to the shifter profiles identified at 210. In some examples, the shift may be published in a tiered manner such that an initial subset of shifters receives a published shift before a subsequent subset of shifters. The shift may be published in a tiered manner based on one or more of likelihood of the shifters to accept the shift, shift owner or institution preference of shifters, clearance, qualifications, frequency of previously completed shifts, attributes of previously completed shifts, location, cost analysis, overtime analysis, or the like.

According to an implementation, shift prioritization may be used to present shifts in a streamlined manner to prevent shifters from being overwhelmed by a number of available shifts. For example, an order or arrangement in which the published shift is presented to each of the identified shifter profiles (e.g., among other shifts that are published to the shifter profiles) may be based on output of a machine learning model. For example, FIG. 2G depicts a flowchart of an exemplary process 280 for using a shift prioritization machine learning model to perform at least a portion of the publishing process at 212 of FIG. 2A. For example, at 282, for each of the shifter profiles identified for publishing, the shift data and information associated with the respective shifter profile may be provided as inputs to the shift prioritization machine learning model. At 284, a predicted probability that a shifter associated with the respective shifter profile accepts the shift may be provided as output of the shift prioritization machine learning model. At 286, based on the predicted probability, an order or arrangement in which to present the published shift among other published shifts to the respective shifter profile may be determined. For example, shifts that have a higher likelihood of being selected by a shifter may be presented or may be presented first to the shifter's profile. Additionally, and/or alternatively, a shifter may be able to parametrically filter attributes to narrow down a list of available shifts by, for example, time, duration, date, location, supervisor, co-shifter, or the like. An initialized parametric filtering may be auto-generated based on a shifter's profile, as disclosed herein.

The shift may be accepted or filled by at least one of the shifters of the identified shifter profiles to whom the shift was published to. For example, one or more shifters may accept the shift through their shifter profiles using a shifter device (e.g., second user device 140), or by any other applicable techniques. At 214, in response to receiving the one or more acceptances of the shift, the shift may be allocated to the one or more accepting shifter profiles to be performed by the associated shifter(s). According to an implementation, multiple shift acceptances for the same shift may be received. The shift itself may require multiple shifters and/or a subset of the shifters that accept the shift may be selected based on one or more factors such as shift owner or institution preferences of shifters, qualifications, frequency of previously completed shifts, attributes of previously completed shifts, location, cost analysis, overtime analysis, or the like. One or more shifters that select a shift may be kept as backup shifters such that they may be called upon in the event of a call-out or the like.

Additionally, shifters may be allowed to request small schedule adjustments that can be compensated by other shifters, with their approval. For example, by a shifter changing a shift from 8 AM-5 PM to 8 AM-4 PM, another shifter may be offered the extra hour earlier in their shift and if they approve the extra hour both parties may receive the schedule adjustment.

At 216, feedback associated with the shift may be received. The feedback received may be related to the processes performed at any one of steps 202, 204, 206, 208, 210, 212 and/or 214. For example, the feedback may be based on the ease of use of generating a shift owner profile at 202. Alternatively, the feedback from 202 may be based on the accuracy of the shift owner profile, an update to the shift owner profile, a change in a status, an update to weights based on a shift generated based at least in part on the shift owner profile, or the like. The feedback may be based on the ease of use of generating a shifter profile at 204. Alternatively, the feedback from 204 may be based on the accuracy of the shifter profile, an update to the shifter profile, a change in a status, an update to weights based on a shift publication or selection, or the like.

Feedback based on 206 may, in one example, be related to a demand predicted by the demand forecasting that drove the initiation of the opening of the shift. Feedback based on 208 may be related to automatic generation of the shift data. For example, if a shift owner changes one or more auto-generated portions of the shift data, then those changes may be part of the feedback received from 208. Additionally, the feedback may include portions of shift data selected by the shift owner when initiating a shift. Further, the feedback based on 208 may be related to shift outcomes that relate to predictions made by the various machine learning models, such as an actual demand associated with the shift, a length of time between publishing and accepting of the shift, whether the shift was accepted or not by each shifter associated with a shifter profile within the subset, whether the shift was subsequently declined and re-allocated, whether the shifter appeared for the shift, whether the shift was requested by one or more other shifter profiles, etc.

Feedback based on 210 may include a response received from publishing a shift, a number of shifter profiles the shift was published to, a speed at which the shift was published, a distance of one or more shifters who the shift was published to, an attribute of the shifter profiles who received the shift, or the like. Additionally, feedback based on 212 may include how many tiers the shift was published to, the makeup of the tiers, or one or more attributes about the tiers. Similarly, feedback based on 210 may include a response received from publishing a shift, a numbers of responses received, a speed of the response received, a distance of one or more shifters who selected the shift, an attribute of the shifters who selected the shift, or the like. Additionally, feedback based on 212 may include which tier of the one or more tiers included the selection of the shift. Further, feedback based on 212 may include any call-outs and/or pick-ups by shifters associated with the shift.

At least some aspects of the above-discussed feedback received at 216, may be utilized by the various trained machine learning models disclosed herein to modify, adjust or retrain the models to improve a performance thereof when applied to the opening, generation, and publishing of future shifts, as discussed in more detail with reference to FIGS. 10 and 11 below. For example, the feedback received at 216 may be used to adjust, add, and/or remove weights and/or layers of one or more machine learning models disclosed herein.

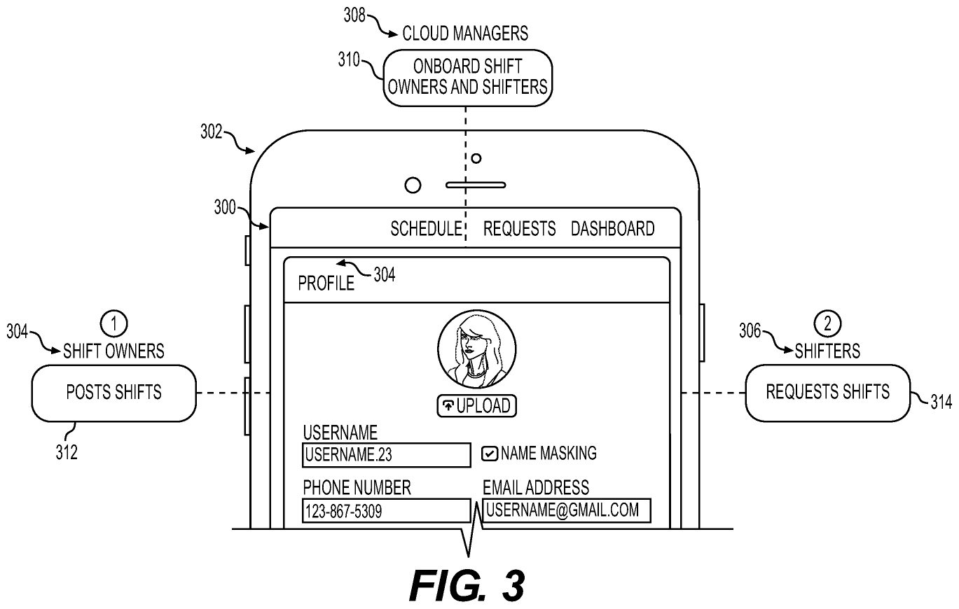

FIG. 3 shows a high-level implementation of the subject matter disclosed herein. As shown, an application 300 (e.g., a mobile application, web application, digital application, cloud application, wearable device application, etc.) associated with institution 105 that is executing on a device 302 provides one or more interfaces to enable varying user types to interact with application 300 for performing functions according their user type. The examples user types may include shift owners 304 (e.g., first user 125), shifters 306 (e.g., second user 135), and cloud managers 308 (e.g., third user 145) associated with institution 105. In some examples, a different version of the application (e.g., first user application, second application, and third user application) may be provided based on user type to restrict or tailor to the specific functions that may be performed by each user type. Cloud managers 308 may onboard shift owners 304 and shifters 306 at 310 to at least initiate the generation of corresponding shift owner profiles and shifter profiles through which shift owners 304 and shifters 306 may log into application 300. Shift owners 304 may post shifts (e.g., open and/or publish shifts) at 312 to connect with shifters that request (and accept) shifts at 314.

According to an implementation, voice control via a voice user interface (VUI) of application 300 may be used by shift owners 304 and/or cloud managers 308 to send chat message or call shifters 306, edit a schedule or specific shift manually via an application, or the like. The VUI may be used to help shift owners 304 and cloud managers 308 interact with a shift application using speech recognition to answer questions, complete spoken commands and text to speech (TTS) to read text out loud. Shift owners 304, cloud managers 308, and/or shifters 306 may use voice control to complete shifts, complete profiles, select shifts, activate training, provide feedback, provide shift notes, provide evaluations, or the like.

In addition to general graphical and voice interfaces of application 300, in some implementations, a smart bot service (e.g., chat service, voice driven service, graphical user interface service, etc.) may be provided to answer questions. The smart bot service may be implemented using Voice User Interface (VUI), Text-to-Speech (TTS), AI, machine learning, statistical learning, LBS, or the like. The smart bot service may also receive, as inputs, shift information, shifter information, and the like to more directly address questions based on knowledge about a shift, shift owners 304, and/or shifters 306. For example, shifter 306 may ask a question about parking locations for a given shift. Based on the shift based information (e.g., shift location) and shifter information (e.g., shifter location), the bot service may determine a parking address and may direct shifter 306 to the parking address. The smart bot service may be implemented across a plurality of shifts, shift types, shift owners 304 and shifters 306, and may also be used for training shifter 306. Accordingly, the smart bot service may improve shift efficiency and reduce institutional costs.

FIGS. 4A through 4E below show example user interfaces of application 300 with which cloud managers (e.g., cloud managers 308) may interact. FIG. 4A shows one example cloud manager user interface 400 of application 300 for initiating generation of a shift owner profile and shifter profile. Through cloud manager user interface 400 of application 300, a cloud manager may, among other things, select an application tool or functionality 402 for viewing and/or managing users. One aspect of user management may include the onboarding or adding of users, where the users may include both shift owners and shifters.

Upon the selection of application tool or functionality 402, a management view 404 may be displayed. Management view 404 may include a list 406 of previously on boarded users for whom profiles have already been generated may be displayed. List 406 may be scrollable, searchable, and/or filterable. Within list 406, at least some attributes of the users' profiles may be displayed. For example and as shown in FIG. 4A, a name 408 and corresponding image, a role 410 (e.g., shifter, shift owner, cloud manager), a market 412, a sub-market 414 and job qualifications 416 for each user may be displayed within list 406. The types of profile attributes displayed within list 406 may be configurable by the cloud manager.

Management view 404 may also include a user interface element 418 that, upon selection, allows a cloud manager to onboard a new or additional user. For example, selection of user interface element 418 may cause a menu or other similar user interface element to be displayed (e.g., overlaying list 406). The menu may include a plurality of data fields to be populated for onboarding the user. At least a portion of the data fields may correspond to a minimum set of attributes to be associated with the user for generation and inclusion in the user's profile, where the minimum set of attributes may be based on a role of the user (e.g., shifter or shift owner). As described in greater detail below, in some examples, information may be entered into the data fields by the cloud manager. In other examples, at least a portion of the data fields may be automatically populated with information retrieved from institution server systems 110 of FIG. 1 or databases 115.

FIG. 4B shows an example menu 440 displayed upon selection of user interface element 418 in FIG. 4A for onboarding a shifter. Data fields 442 of menu 440 may include a user identification 444, a role 446 (e.g., shifter), applicable location-based fields 448, 450, and job qualifications 452, among other information items representing a minimum set of second attributes to be associated with the shifter via the shifter's profile. Applicable location-based fields 448, 450 may be based on a type of institution 105. For example, if institution 105 is affiliated with a national brand of hotels or other similar hospitality services, there may be several markets served across the nation with some of the larger markets (e.g., major cities) being broken down further into submarkets. Accordingly, applicable location-based fields 448, 450 may include a market 448 and sub-market 450 with which the shifter is to be affiliated (e.g., based on geographical closeness, familiarity, or qualifications).

FIG. 4C shows an example menu 460 displayed upon selection of user interface element 418 in FIG. 4A for onboarding a shift owner. At least a portion of the data fields 462 may be similar to data fields 442 of menu 440. For example, data fields 462 may include at least user identification 444, role 446 (e.g., shift owner), and market 448 data fields, among other information items. Data fields 462 may also include a different location-based field, such as properties 464 within the market, among other information items. Continuing the above example where institution 105 is affiliated with a national brand of hotels, there may be multiple properties for which shifts need to be fulfilled within each market. A particular shift owner may be assigned to or affiliated with a certain subset of those properties (e.g., based on geographical closeness or familiarity with the property or property type). Data fields 462 may represent a minimum set of first attributes to be associated with the shift owner, as discussed above with reference to 202 at FIG. 2A.

Data fields 442, 462 described with reference to FIGS. 4B and 4C may include one or a combination of text entry fields and fields with pre-populated, selectable drop down options, where one or more options may be selected dependent on the field.

As part of the onboarding process, all or at least a part of the shift owner profile and/or the shifter profile may be generated automatically utilizing one or more of a system integrations with one or more institution server systems 110 of FIG. 1 or databases 115. For example, the cloud manager may enter a name, email address, or other similar contact information of the user into user identification 444 data field of menu 440, 460 to trigger the retrieval of the corresponding user's information from one or more institution server systems 110 of FIG. 1 or databases 115 to populate the remaining data fields. Additionally or alternatively, the cloud manager may manually populate a portion or all of the data fields.

In addition to the minimum set of attributes associated with the respective shift owner and shifter profiles generated during the onboarding process, additional attributes may be manually added to the set by the users. In further examples, the additional attributes may be automatically added to the set and/or existing attributes may be updated at least periodically utilizing the system integrations with one or more institution server systems 110 of FIG. 1 or databases 115.

As one example, attributes of a shift owner profile may include shift owner information such as the shift owner's identification information, position, job title, applicable location (e.g., a building, an area, a geographical fence, a management area the shift owner is responsible for, etc.), preferences (e.g., shift preferences, shifter preferences, GUI arrangement preferences, etc.), or the like. The attributes of a shift owner profile may also include the shift owner's job related information such as job credentials, security clearance, title, status, team, shifts that the shift owner is designated to manage, applicable locations associated with the job, or the like. The attributes of the shift owner profile may further include shift owner history information such as past shifts (e.g., generated, initiated, approved, or managed), past shift rankings, past attributes selected over one or more shifts, optimization scores, call-outs or missed shifts, overtime allocation, or the like.

As another example, attributes of a shifter profile may include shifter information such as the shifter identification information, qualifications (e.g., certifications, training, minimum requirements, test results, etc.) position, job title, applicable location (e.g., a building, an area, a geographical fence, a management area the shift owner is responsible for, etc.), preferences (e.g., shift preferences, hours, distance from key locations, co-worker preferences, manager preferences, shift owner preferences, shift type preferences, GUI arrangement preferences, etc.), or the like. The attributes of a shifter profile may also include the shifter's job related information such as job credentials, security clearance, title, status, team, shifts that the shifter is designated to fill, applicable locations associated with the shifter, or the like. The attributes of a shifter profile may further include shifter historical information such as past shifts (e.g., signed up for, completed, etc.), past shift rankings, past attributes selected over one or more shifts, optimization scores, call-outs or missed shifts, overtime allocation, or the like.

FIG. 4D shows an example shifter profile 470 following generation at 204 of FIG. 2A. Shifter profile 470 may be viewable by a shifter, a shift owner, and/or a cloud manager through a respective interface of application 300. In the specific example shown in FIG. 4D, shifter profile 470 may be displayed within a profile view 471 of user management functionality 402 through cloud manager user interface 400 of application 300. Shifter profile 470 may include a plurality of sections 472, 474, 476, 478 for displaying information of varying attribute types, where one or more of the items of information may be expanded upon to see additional information such as through a drop down or a pop-up. For example, and as shown in FIG. 4D, shifter profile 470 may include a summary section 472, a shift history section 474, a user information section 476, and/or a qualifications section 478.

Summary section 472 may include a shifter name 480, image 482, location 484, contact information 486, and a work summary 488 that includes average hours, total hours, and total shifts. In addition to an email address, telephone number or the like, contact information 486, as shown, may include an indicator of whether the user is online and/or user interface elements selectable to initiate communication with the shifter using variable modes (e.g., email, phone, instant messaging). Shift history section 474 may include a filterable list of past shifts filled by the shifter, where the past shifts may be identified by a name of the shift, a date of the shift, and/or a property where the shift was performed, among other similar information. User information section 476 may include at least a portion of the minimum set of second attributes associated with the shifter during onboarding, including a user role, a region, a market, and submarket. Some job functions or types to be performed as part of a shift may require training (e.g., a predefined number of hours performing that job function or type). Qualifications section 478 may include a list of different types of job functions or types previously performed in past shifts by the shifter and a visual display of a training status associated with the job function or type.

Returning to FIG. 4A, for each on boarded user displayed in list 406 within management view 404, a user interface element 419 indicative of additional functionalities that may be performed with respect to the generated profile of that on boarded user may be displayed. When the cloud manager hovers over and/or selects user interface element 419 associated with a particular user, a menu 420 displaying the additional functionalities may be displayed. Menu 420 may be a drop-down menu, a pop-up menu, or the like. The additional functionalities may include a quick view functionality 422, an edit functionality 424, and a delete functionality 426.

Quick view functionality 422 allows a portion of information from the particular user's profile to be viewed by the cloud manager. For example, when quick view functionality 422 is selected from menu 420, a quick profile view may be displayed. As one example, the cloud manager may hover over and/or select user interface element 419 associated with the particular user associated with shifter profile 470 discussed with reference to FIG. 4D. When the cloud manager then further selects quick view functionality 422 from menu 420, a quick profile view 490 may be displayed within management view 404, as shown in FIG. 4E. Quick profile view 490 may have limited information about a user and the cloud manager may expand the profile to a full profile by selecting a user interface element 492. In some examples and as shown in FIG. 4E, the limited information included in quick profile view 490 may correspond with summary section 472 of shifter profile 470 described with reference to FIG. 4D.

Returning to FIG. 4A, edit functionality 424 of menu 420 allows the cloud manager to edit the particular user's profile (e.g., through a same or similar interface of the application shown in FIG. 4D). Delete functionality 426 of menu 420 allows the cloud manager to delete the particular user's profile entirely. The cloud manager may perform such a deletion if the user is no longer employed or eligible based on rules or practices of institution 105 to open and manage the filling of shifts (if a shift owner) and/or accept shifts (if a shifter).

Additionally, as shown in FIG. 4A, management view 404 may display a monthly dashboard 428. Monthly dashboard 428 may include information about a number of new shifters 430, trained shifters 432, and shifts completed 434.

FIGS. 5A and 5B show example user interfaces of application 300 with which shift owners responsible for managing and filling shifts may interact with to perform various tasks. FIG. 5A shows a shift owner's dashboard 500. Dashboard 500 may include a schedule view 502 having a plurality of features. One example feature enables the shift owner to select one or more types of shifts 504, including scheduled shifts, published shifts, unpublished shifts, training, accepted shifts, and the like, and a defined period of time 506 (e.g., a day, a week, or a month), to generate a schedule 508 that provides an overview of shifts of the selected types spanning the defined period of time. Additionally, the shift owner is able to view the shifters who have accepted shifts within the defined period of time (active shifters 510). Further, the shift owner is enabled to print or export the schedule 508 by selecting a print control element 512 or an export control element 514, respectively.

Another example feature of schedule view 502 may enable the shift owner to generate a shift by selecting a generate shift control element 516. In some examples, one or more shift templates 518 displayed may be selected and utilized in the shift generation process. Shift templates 518 may be based on a shift type and/or job functions or specialties associated with the shift. Shift templates 518 may have shift owner specific instructions or the like that were used to generate previous shifts of a similar type. Use of shift templates 518 may enable quicker population of the shift data during the generation process. Additionally or alternatively, upon selection of generate shift control element 516, a shift generation user interface described in more detail below with reference to FIG. 5B may be displayed and utilized for generating the shift. A further example feature of the schedule view 502 may enable the shift owner to publish previously generated but unpublished shifts by selecting a publish control element 520.

FIG. 5B shows a shift generation user interface 530 of application 300. In some examples, shift generation user interface 530 may be a separate user interface as shown. In other examples, shift generation user interface 530 may be overlaid on another view, such as schedule view 502 described above with reference to FIG. 5A.

Shift generation user interface 530 may be displayed in response to receiving an indication to initiate an opening of a shift discussed above with reference to 206 of FIG. 2A. Shift generation user interface 530 may include a plurality of sections 532, 534, 536 related to varying aspects of the shift data to be captured for generating the shift. Sections 532, 534, 536 may include data fields into which the shift data may be entered. The data fields may include one or a combination of text entry fields and fields with pre-populated, selectable options, where one or more options may be selected dependent on the field. A temporal section 532 may capture date and time related information for the shift, including a start date, an end date, whether the shift is a recurring shift, and if so, on which days and for what number of weeks should this shift recur, among other similar information. A job section 534 may capture a job function associated with the shift, a number of shifters needed to fill the shift, and whether or not the shift is a training shift, among other similar information. A details section 536 may capture various shift-specific information, such as a parking location for the shifter, a clock location, a building location, a meeting location (e.g., at the beginning of the shift), any specifics instructions, and additional shift notes, among other similar information.

As briefly described in above with reference to FIG. 2A, in some implementations, at 208, all or at least a portion of the shift data (e.g., the data fields within sections 532, 534, 536) may be automatically generated (e.g., populated) based on the indication and/or one or more first attributes of the shift owner profile for the shift owner that is generating the shift. In other implementations, the shift owner may enter the information to populate the data fields or modify some of the automatically populated data fields based on the shift being generated.

To provide a non-limiting example of the indication-based automatic generation, if the indication is based on a calendar-related opening actuated by the shift owner (e.g., via schedule 508), a date and time for the shift may be known and used to populate temporal aspects of the shift within the shift data. To provide non-limiting examples of the attribute-based automatic generation, a portion of the shift data may be generated based on the following: on a location associated with the shift owner, a type of shift the shift owner is authorized to initiate, a duration of shift the shift owner is authorized to initiate, historical shifts that the shift owner has initiated (e.g., including properties of the historical shifts that the shift owner has initiated), a sequentially previous shift opened by the shift owner, a highest ranked shift opened by the shift owner (e.g., if 95% of the shifts opened by the shift owner are for a given category of work, that category of work may be pre-populated in the new shift being opened), or the like.

The automatic generation may also include providing multiple of the first attributes in a ranked order for ease of use. For example, if 60% of the shifts opened by the shift owner are for a given category of work, that category of work may be pre-populated in the new shift being opened. Additionally, the next most frequently opened shift, for example a shift that is opened 25% of the time may be provided as an option (e.g., for selection, via drop down menu, etc.), or the like.

Generation user interface 530 may also have a template feature 538 that allows the shift owner to select to make a shift template using at least a portion of data used to populate sections 532, 534, and/or 536. The shift template may be saved and presented to the shift owner (e.g., shift templates 518 presented in schedule view 502) so that the user may more quickly generate a similar upcoming shift using the template.

Additionally, as described above with reference to 208 at FIG. 2A and FIG. 2C, as the shift is being generated, a trained shift attractiveness machine learning model may receive, as input, the shift data from shift generation user interface 530 and output a probability of the shift being accepted by a shifter based on its currently configured attributes. The probability may be graphically displayed as a shift attractiveness score 540 within shift generation user interface 530. Additionally, shift generation user interface 530 or any other applicable interface may provide suggestions or recommendations to the shift owner on how to adjust a shift to make it more attractive to increase the probability that the shift will be accepted. For example, the suggestions may include modified timings for the shift, modified pay, modified qualifications, alternative shift days, length of shift, or the like. The suggestions may also indicate or graphically show a predicted adjusted probability (e.g., percentage) that that the shift would be accepted if one or more of the suggestions were to be implemented based on additional output received from the shift attractiveness machine learning model (e.g., responsive to the modifications to the shift data inputted). In other implementations, the adjustments to the shift to make it more attractive may be automatically applied to the shift.

Shift generation user interface 530 may further include a shift summary 542 that previews how the shift will look on a schedule, such as schedule 508 shown in FIG. 5A. Once the shift owner has completed entering and/or modifying pre-populated information to generate the shift, the shift owner may select a publish control element 544 to publish the shift. Alternatively, the shift owner may discontinue generation of the shift by selecting a cancel control element 546 or may save a draft of the shift to come back to later using a save control element 548.

The example user interfaces of application 300 shown above in FIGS. 4A through 5B are non-exhaustive, non-limiting examples. Different graphical or visual schemes may be utilized.

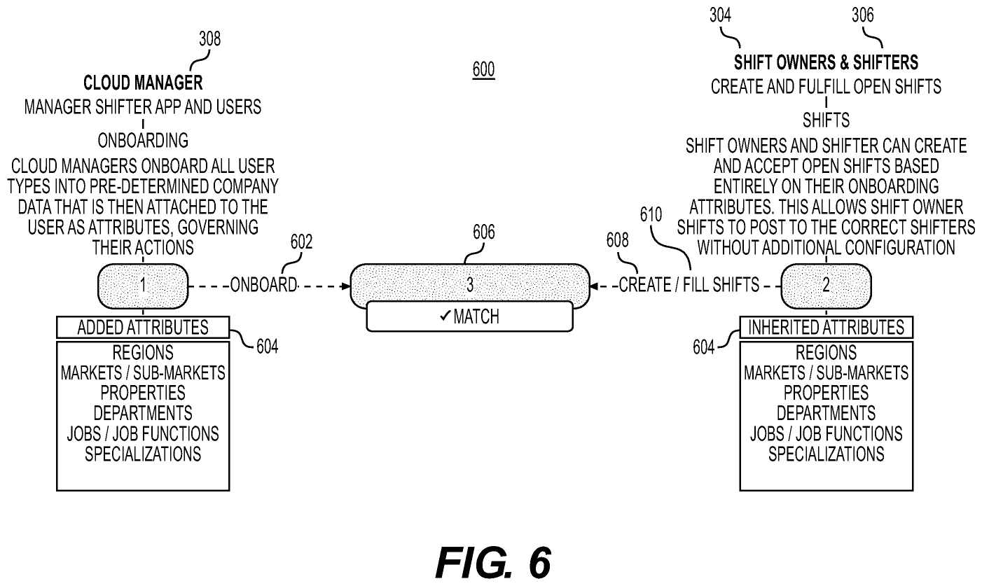

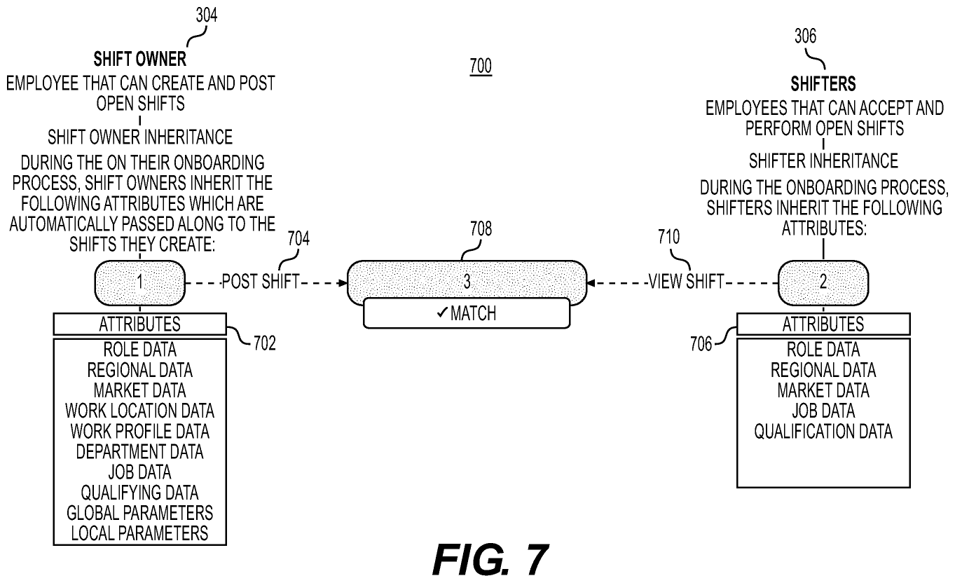

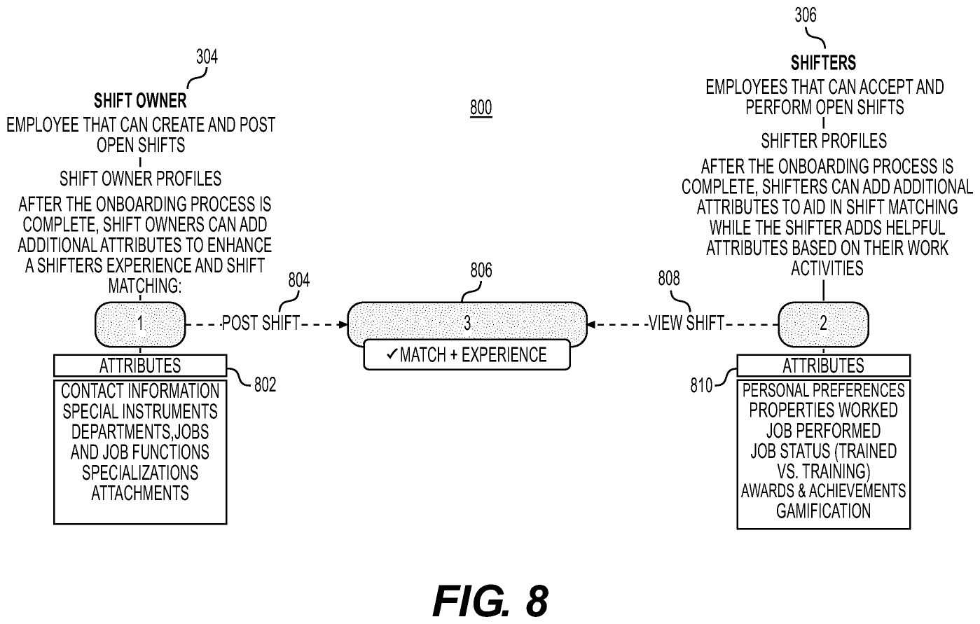

FIG. 6 is a conceptual diagram 600 that shows an example implementation of an onboarding process to enable the attribute-based shift generation and selection disclosed herein. As shown, a cloud manager 308 (e.g., at or associated with institution server system 110) at 602 may onboard user types (e.g., shifter owners 304 and shifters 306) into pre-determined institution data that is then attached to the user (e.g., via a generated user profile) as attributes 604, governing their actions. As shown, attributes 604 may include regions, markets/submarkets, properties, departments, jobs/job functions, and specializations of the user. In some examples, these on boarded attributes 604 may be a minimum set of attributes that are included in the user's profile and thus inherited by the user. Through attribute matching at 606, shifts may be generated at 608 by shift owner users and published to/accepted (e.g., filled) at 610 by shifters 306 based on their respective attributes 604, as described in more detail with reference to FIGS. 7 and 8. For example, a shift may be automatically generated (e.g., shift data may be defined) based on the shift owners' region, market/submarket, properties, departments, jobs/job functions, specialization needs, or the like and a shifter may be provided and/or accept a shift based on the shifter's own attributes.

FIG. 7 is a conceptual diagram 700 that shows an example implementation of the attribute-based shift generation and selection process described herein. As previously described with reference to FIG. 6, a minimum set of attributes 610 may be attached to shift owners 304 and shifters 306 during onboarding. These attributes 610 may be inherited by the respective shift owners 304 and shifters 306 (e.g., inherited attributes). As shown, a shift owner's inherited attributes 702 may be auto-populated into data fields for shifts being generated and published by the shift owner 304 at 704. Shift owner inherited attributes 702 may include, but are not limited to, role data, regional data, market data, work location data, work profile data, department data, job data, qualifying data, global parameters, local parameters, or the like. The shift data fields may be auto-populated based on the shift owner, shift owner profile, shift owner attribute (e.g., location, status, etc.), time of day, date, or the like. As shown, a shifter's inherited attributes 706 may be used to match shifters 306 with shifts posted by shift owners 304 through matching process 708. For example, a shifter 306 having shifter inherited attributes 706 that match at least a portion of the shift data generated based on shift owner inherited attributes 702 may be able to view the shift at 710 (e.g., the shift may be published to the shifter 306). Shifter inherited attributes 706 may include role data, regional data, market data, job data, qualification data, and the like.

FIG. 8 is a conceptual diagram 800 that shows another example implementation of the attribute-based shift generation and selection process disclosed herein. Shift owners 304 may add additional attributes 802 to their shift owner profiles beyond on boarded attributes 604 (e.g., beyond the minimum set of attributes or shift owner inherited attributes 702) to enhance shift generation and/or the shifters' experience as well as the shift matching process. Additional shift owner attributes 802 may include, but are not limited to, contact information, special instructions (e.g., shift related, location related, parking, transportation, requirements, etc.), departments, jobs/job functions, specializations, attachments, or the like. As shown, shift owner 304 may generate and publish shifts at 804. According to an implementation, the shifts may be generated based on shift owner's attributes 604, 702, 802. For publishing, the shifts may be matched at 806 with shifters 306 based on a number of factors including experience based factors defined by the shifters' profile (e.g., including at least attributes 604, 706). Shifters 306 that match may view the shifts at 808.

Shifters 306 may also add additional attributes 810 to their shifter profiles beyond on boarded attributes 604 (e.g., beyond the minimum set of attributes or shifter inherited attributes 706) which may augment the ability for the system to match shifters 306 with shifts. Additional shifter attributes 810 may be shifter related or work related and may include personal preferences, properties/locations worked, distance from work location, jobs performed, job status, awards, accolades, achievements, training, certification, or the like.

According to implementations of the disclosed subject matter, the system and techniques disclosed herein may enable matching shifter attributes, including location, skills, and shift preferences, with shift owner needs while aligning recruiting to have enough shifters with the right skills needed to pick up open shifts. Such techniques may include forecasting demand for jobs, specializations, shift days/times, shift length and work locations to identify needs and optimize recruitment, staffing levels and training priorities. Public data such as weather, regional and local events as well as historic data may be leveraged to aid in shaping levels and skill of shifters needed to meet demand.

As previously discussed, performance optimizers and/or incentives may be provided. For example, pay incentives may be provided utilizing the adaptive pay machine learning model. Additionally, shift owners may provide notes/comments on employees for a given shift and shifters may provide notes/comments on their shifts. The system may use natural language processing to evaluate these notes and do sentiment analysis to improve other optimizers such as evaluating shift satisfaction. Such an implementation may use NLP and SOTA Machine Learning/Deep Learning methods such as sequence models, Transformers, Lambda Networks, or the like. Further, gamification and other reward systems may also be used for performance optimization and incentives.

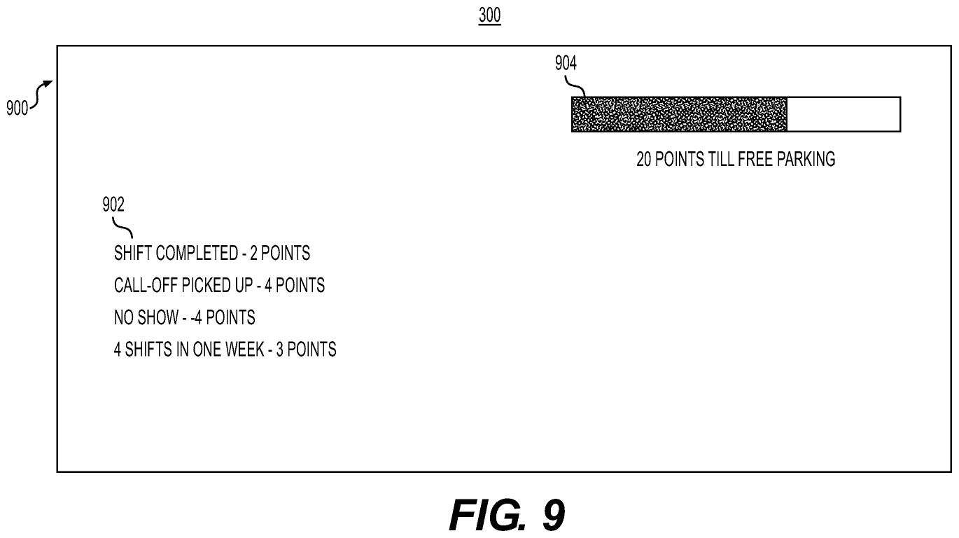

As disclosed herein, a gamification module may be used for incentivizing and motivating users in ways other than pay and traditional benefits to achieve beneficial outcomes. FIG. 9 shows an example gamification interface 900 of application 300. Gamification interface 900 may be a separate user interface of application 300 or may be overlaid on one or more other views of application 300. Gamification interfaces 900 may be presented to both shifters and shift owners. In this example, gamification interface 900 is being presented to a shifter. Gamification interface 900 shows a current status 902 and an upcoming reward state 904 associated with the shifter. Current status 902 shows that points received (or alternatively the points deducted) for completed shifts, call-offs picked up, no show, and a number of completed shifts within a predefined time period. Upcoming reward state 904 shows that the shifter needs 20 additional points in order to unlock free parking (e.g., for a given month, year, time duration, until a status is maintained, etc.). FIG. 9 also provides a key for the shifter to understand how to earn additional points, and how many points each corresponding item adds or removes. It will be understood that although a simple gamification implementation is shown in FIG. 9, any applicable gamification and corresponding incentive technique may be used including a dynamic display, tracking, projection module, or the like.

Additionally or alternatively, shifters may receive badges, awards, recognition, etc., when certain thresholds have been met. These can be viewed privately or shared publicly, such as on a leader board. Milestones for receiving these includes things like hitting targets, goals and achievements such as: average weekly hours worked, no-shows or call-offs targets, and the number of jobs a shifter is trained in including specializations and certifications. Accumulated points may then be used in the store to purchase perks/rewards. These rewards include things such as additional paid time off (PTO), shift premiums (where a shifter see shifts in advance of others), shift related or shift unrelated gifts (e.g., parking, gas, smartphones, etc.), travel incentives (e.g., discounts on Uber/Lyft to and from work, lunch, etc.). Such gamification techniques may contribute to shifter satisfaction, achieve business objectives, reduce negative outcomes (e.g., no shows, call-offs, etc.), or the like. A machine learning model may be used to improve the gamification module based on evaluating the incentives, performance, satisfaction, business objective achievement, and negative outcome reduction.

Gamification may also be implemented for shift owners such that the shift owners are incentivized and motivated in ways other than pay and traditional benefits to achieve beneficial outcomes. The same or similar gamification techniques and incentives may be used for shift owners as disclosed for shifters, to promote use of shift optimization and quantity/quality of shifts. Such gamification techniques may contribute to shift owner satisfaction, achieve business objectives, reduce negative outcomes (e.g., shift cancellation, un-filled shifts), or the like. A machine learning model may be used to improve the gamification module based on evaluating the incentives, performance, satisfaction, business objective achievement, and negative outcome reduction. As an example, the feedback associated with a shift received at 216 of FIG. 2A may be input into a gamification machine learning model such that the feedback is used to adjust, add, or remove weights and/or layers of the gamification machine learning model to improve future outputs provided by the gamification machine learning model.

In addition to the above-discussed features and implementations of the system, institutional performance may be evaluated based on key performance indicators (KPIs), targets, goals, thresholds, or the like. Such institutional performance may be provided by one or more machine learning models or via algorithms configured to receive shift information, shifter information, shift owner information, and/or instructional information and output the institutional performance based results. As an example, a number of unfulfilled shifts over a predetermined period of time may be reported and may be used as in indicator of a shift owner's success in generating shifts and/or incentives to ensure shift fulfillment. Additionally, an indication of expected unfulfilled shifts vs actual unfulfilled shifts may be output to show performance improvement or degradation. The institutional performance may be provided via any applicable manner such as via reports, dashboards, recommendations, gamifications, and/or other techniques to provide and promote overall institutional performance.

Further, in some implementations, a line-of-business (LoB) management system may be integrated with the shift based system disclosed herein. The LoB management system integrated with the shift based system may enable a broad range of organizational management capabilities that support end-to-end starting, running, and management of an on-demand organization. For example, shift based information, as disclosed herein, may be integrated with accounting software such that financial forecasting and planning can be facilitated in conjunction with the shift information.

In addition to adaptive pay discussed above with reference to FIG. 2D, overtime optimization may also be conducted to manage overtime pay. Overtime may be optimized to balance the amount of overtime paid with the cost of adding additional shifters in view of upcoming needs, trends, and/or historical analysis. For full-time shifters, an engine may assess if the cost of hiring a new shifter and incurring the sunk benefits costs is better than offering overtime. The engine may incorporate the overall cost of the workforce and not just an individual shifters cost for a given shift. These savings would then be available to adjust shifter rates for companies using a shared service model or to be allocated for covering some of the pay incentives and benefits discussed herein. Additionally, the overtime optimization may consider temporary or seasonal hiring and pay in view of the overall cost associated with such overtime hiring or pay. For example, the system may use an optimization algorithm or machine learning model to determine the cost benefit of hiring, onboarding, and training additional individuals due to seasonal adjustments verses overtime allocation to existing shifters.

According to an implementation, an all hands on deck scenario may be provided where a situation may occur where more resources than would otherwise be necessary based on preset rules such as training, certifications, etc., may be needed. For example, such situations may come up due to weather conditions (e.g., hurricanes), heath pandemics, fires, regulations (e.g., Restrictions on J1 visas), Labor needs (e.g., strikes), large events (e.g., sporting events, rallies, etc.), or the like. Machine learning may be used to optimize all-hands-on-deck scenarios that automatically redefine standard requirements such as job and specialization shifter assignments and related training thresholds to ensure the maximum number of shifters can see open shifts during these special events requiring all hands on decks. Additional modules such as adaptive pay and overtime optimization may also be incorporated into the all hands on deck scenario module.

According to an implementation, a dynamic hierarchy module may be implemented that matches the best shifters to a given opportunity. The module may optimize which shifters see open shifts first, based on their fit with the location, job and specialization experience/expertise as well as proximity to work location, associated with a shift. The determination of “best” shifters may be made by a machine learning model that receives both shifter inputs as well as shift inputs to determine one or more shifters best positioned for a given shift. The shifters may be selected based in part on their past performance and/or qualifications and in part based on shift attributes such as location, hours, etc.

According to an implementation, a shift requesting module may be used to enable shifters to request shifts that may not be open or available to the shifter. For example, a shifter may have hours available for a shift, but that shift may already be filled by other shifters or not available in times/days that work for the given shifter. The shift requesting module may allow shifters to request a specific shift or specific attributes (e.g., time, duration, location, etc.), which then propagate the offer to other shifters to swap their shift or for additional shifts to be added that are a better fit. The shift requesting module may be provided via an interface that enables a shifter to request shifts or shift attributes. According to an implementation, if approved by each given shifter, a shifter seeking a shift may be placed in contact with another shifter to collaborate and determine shift allocations.

According to an implementation, a shifter driven block shift module may enable one or more shifters to request or sign up for shifts in dynamic blocks of time instead of pre-defined blocks of time. A shifter may view a published shift and may determine that although the shifter is not available to fulfil the entire published shift, that the shifter is able to fulfill a portion of the shift. Accordingly, the shifter may be able to request or sign up for the portion of the shift that the shifter is available for. The shifter may be designated the corresponding portion of the shift as a provisional designation such that if the remaining portions of the shift are not selected by other shifters, a back-up shifter that selects the entire shift may be provided the shift.

According to an implementation, training may be optimized using a training optimization module. Different shifters may train at different rates. For example, a housekeeper may be trained in 40 hours whereas a front desk clerk may take 80 hours to train. A machine learning module may receive, as inputs, training history and training data to determine past training techniques and times. The machine learning module may identify best practices that lead to faster training. It may also provide training recommendations based on these learnings. For example, the machine learning module may output images or recommend generating training videos for given tasks that benefit from visual training. Videos may be valuable training tools but may need to be accessed through cumbersome links or third party webpages. According to implementations, the shifter may access training videos through the same application (e.g., application 300) that enables the shifter to select shifts such that the shifters shift related content including shift times and shift details are all located within the same application. The videos may be linked to third party applications such that they are embedded with the same application and pulled from the third party applications. Shifters may be able to provide reviews to the videos, allowing videos and other training content to improve over time. It will be understood that although videos are disclosed herein, any applicable media such as images, sounds, virtual reality, augmented reality, holograms, wearable interfaces, or the like may be used instead of videos.

According to an implementation, hard coded optimization algorithms, machine learning, and/or statistical learning may be used to forecast skill gaps and recommend actions and course corrections to plan and align skills with forecasted demand. Such forecasting of skill gaps may enable sufficient resource availability with the required skills to meet demand. Additionally, based on the forecasted skill gaps, training recommendations and/or programs may be recommended. As an example, a forecast may indicate an upcoming increased demand for banquet housemen who set up and tear down events. The forecast may be paired with a skill analysis which indicates that a current shifter pool may not meet the forecasted banquet houseman demand. Accordingly, the system (e.g., using a machine learning model) may determine that a housekeeping houseman shifter can more easily update his or her qualification to become a banquet houseman based on past such transitions. Accordingly, a notification or other form of encouragement may be provided to housekeeping housemen to catalyze the addition of additional banquet housemen by training housekeeping housemen. The notifications and/or other forms of encouragement may be timed and/or capped such that existing shifters' qualifications and related shifts are considered to avoid cannibalization of shifts associated with the existing qualifications.

According to an implementation, a job assistant module may be provided. Shifters may perform multiple jobs and apply a variety of specializations across multiple locations and job types. These variances may make it challenging to quickly acclimate to their changing environments and required skill sets. Helpful information based on a shifter's situation may be provided using augmented reality, geofencing, coordinate information (e.g., GPS, Bluetooth, tags, etc.), and one or more machine learning models. This information may be contextual in nature such as reminding a shifter when they last performed this shift and who they worked with. It could be in the form of AR, showing a shifter information about the specific work they are trying to perform. For example, a housekeeper may visually see where to place things in a room based on a hotel's brand requirements.

The job assistant module may use institutional knowledge to generate the content for assisting a shifter. Continuing the previous example, a hotel may provide room layouts which may be used to generate the AR renderings of the room to assist a housekeeper when placing items around the room. The institutional knowledge and/or the job assistant module content may be stored at an institutional server such that it is protected from third party use. It may only be accessed by a shifter performing a shift related to the respective institution.

The job assistant module may be tiered such that if a shifter is new to a given shift (e.g., does not meet a threshold number of times working a given shift), the shifter may be required to use the job assistant module and/or verify its use. As a given shifter becomes more experienced with a given shift (e.g., meets one or more thresholds), the shifter may not need to use the job assistant module at a same level as a new shifter. Accordingly, the job assistant module may improve productivity and/or work quality.

A geo-awareness module may be implemented. It may optimize manual activities such as punching in and out of a clock, notifying that a shifter has arrived at a shift location, etc. as traditional techniques for doing the same often cause breakdowns, inefficiencies and require rework. By using geofencing, a shifter's location can trigger activities such as time tracking, on time/late arrival notifications, work assignments and insights. The shifter's location may also triggers shift related items such as activating or warming up machinery, turning on lights and temperature control, downloading job assistant module content, sending notifications, or the like. For example, a supervisor may be notified when a shifter's location activates a notification trigger indicating that the shifter is on location.

The geofencing may be activated using any applicable technique and equipment such as GPS sensor based triggers, Bluetooth triggers, tags, facial recognition, biometrics, etc. A shifter may control the location triggering by providing access through a device or may use a mobile application to select enabling geofencing related activities when arriving at a shift. For example, a device on which application 300 is running, such as device 302, may include GPS sensors that may collect and provide data to application 300 when it is running on device. Additionally or alternatively, properties of institution 105 may have one or more Bluetooth beacons set up (e.g., creating a perimeter around one or more areas of the properties). The beacons may receive signals from device 302 (at least when application 300 is running) once device 302 is proximal to the beacons.

According to an implementation, location based services (LBS) module may be used, as discussed herein. Larger markets may make some work locations less optimal or attractive based on where a shifter lives or would need to travel from in order to complete a shift. For example, a shifter living in downtown Atlanta may have a full-time job working at the airport in Southern Atlanta. On work days, while at her full-time job (e.g., not using the shifter configuration disclosed herein), shifts near the airport or downtown may be determined to be more attractive than shifts coming from locations in Northern Atlanta. On other days, when the shifter is at home, shifts in Northern Atlanta may be more attractive. A combination of LBS, GPS, Map Services (ArcGIS), a Calendar API, and/or a machine learning model may be used to better coordinate and provide shifts to a shifter. Using such an LBS module may reduce call-offs or missed shifts as they may prevent location based errors in signing up for shifts, traffic concerns, and fatigue from traveling.

In addition to or in conjunction with LBS, geo-awareness, and/or geolocation, a technology control module may be implemented. Traditionally, workers may manually turn on devices, lights, cleaning tools, etc., in an assigned workspace at the beginning of a shift. The technology module may be used with a software application to automatically connect to and control nearby devices, systems, lights, tools, logging systems, or the like to increase shifter productivity and reduce time spent. The devices and systems may be controlled based on input provided by an institution associated with the shift or may automatically be determined based on an optimization driven machine learning model. The machine learning model may output optimal devices and systems to control and what controls to implement based on observed efficiencies through inputs associated with the devices and systems.

Similarly, an automated time recording module (e.g., a configurable interface) may be implemented as an improvement from shifters manually clocking in/out using a clock provided at a workplace for any and all given shifts. The automated time recording system may also alleviate sanitation concerns as no physical contact may be required to log time. The automated time recording module may provide an application that records check in time (e.g., based on location detection such as via geofencing, GPS, Bluetooth, etc.) or connects to a device with clock functionality. In either implementation, in and/or out times may be recorded without tangible interaction with any equipment.

According to an implementation, same day pay may be implemented. For many shifters, shifts selected in accordance with the techniques disclosed herein may be secondary or back-up jobs. Their regular job may likely be on a traditional weekly, by-weekly or monthly payroll cycle. Many shifters may select on-demand shifts to pick up supplemental income and as a result may value a more flexible payout model. A same-day pay open source API may be used to pay shifters when a shift is completed. The system may enable a cloud manager the ability to set global rules and a shifter may be able to provide pay preferences via setting in their personal preferences. A shift owner or other entity may be able to confirm the completion of a shift to satisfaction (e.g., a simple completion indication, a rating, a ranking, an indication of a partial completion, etc.) via an interface.

According to an implementation, a smart notification optimization module may be provided. Notification can often be overwhelming as a type and timing of notifications can be triggered through pre-set logic that is often limited in its ability to deliver the right message at the appropriate time. A machine learning module may be used to monitor and score notifications based on their overall utility and usefulness to each user type. The system may make and/or implement recommendations to users that will help them optimize their notification experience. The machine learning model may determine the effectiveness of notifications based on tracking actions taken or not taken base on the nonfiction. For example, if a given notification about an newly open shift is provided to a number of shifters, the machine learning model may receive, as inputs, the number of shifters that clicked through the notification to view the open shift, that ignored the notification, that cleared the notification, that changed a notification setting after receiving the notification, the amount of time spent viewing the notification, or the like. By optimizing notifications, shifter and shift owner satisfaction may be increased as the system may optimize the notifications the shifter and shift owners receive based on shifter and shift owner preferences, and such that the shifters and shift owners start to receive only notifications that are most relevant to them.

According to an implementation, a professional module may support professional development and/or performance. The professional module may provide a high level optimization of a workforce to monitor the workforce to make recommendations for new jobs, specializations, advancements, and succession planning. A machine learning model may be used to review an institutions overall shifter setup to periodically or consistently evaluate a number of inputs from the workforce, work needs, industry, market trends, and the like and output suggestions about a workforce size, training, qualification, and industry focuses and to also plan for turnover at one or more levels including on the institution level, cloud management level, shift owner level, shifter level, or the like or a combination thereof.

One or more implementations disclosed herein include a machine learning model. For example, a machine learning model may be trained and then deployed and applied at one or more stages throughout the shift opening, generation, and/or publishing processes described with reference to FIG. 2A through 2G in order to output particular predictions for upcoming shifts. The machine learning model may also be monitored to modify, adjust, or re-train the model based on feedback, if needed, to improve the accuracy model. Additionally, the particular predictions for upcoming shifts output by each of the machine learning models may be provided as inputs to further decision processes.

Generally, a machine learning model may be a regression-based model, supervised model, unsupervised model, convulsion model, or any other applicable model that accepts the data (e.g., including feedback data) as input data. The machine learning model may be of any suitable form, and may include, for example, a neural network or deep neural network. The machine learning model may compute an output as a function of time, quality, frequency, ranking, importance, or any other applicable factor that improves performance of a corresponding system component. The functionality of the machine learning model (e.g., based on the weights associated with the machine learning model) may be learned by training the machine learning model with training sets. According to implementations, a machine learning model may generate outputs based on given input features and/or hyperparameters. Hyperparameters may include but are not limited to, learning rate, loss function, batch size, optimizer, regularizer, layer count & shape, activation function, normalization, weight initializer, feature selection, etc.

The training sets may be, for example, supervised training sets that include a plurality of inputs and an associated one or more tagged outputs. The machine learning model may be trained by supervised, unsupervised or semi-supervised learning using training sets comprising data of types similar to the type of data used as the model input. The training sets may be generated based on historical information including shift generation information, profile generation information, shift allocation, shift fulfillment, shift efficiency, shifter attributes, shift type, shift start time, shift stop time, location IDs, location based volume drivers (e.g., rooms occupied), year, day of year, day of week, holiday, weather, temperature, property type, property class, region, previous day/week/month etc. demand, a number of previous day/week/month during a previous year's demand, IDs of a number of most likely shifters, and the like. The training set may be used by a machine learning algorithm to allocate weights to generate a machine learning model. As an example, the auto-generation of at least a portion of the shift data based on shift owner attributes may be based on training data that caused a machine learning algorithm to weight one or more specific attributes higher than one or more other attributes. Accordingly, the machine learning model may be trained to generate an output such as an improved shift owner or shifter profile generation and job performance, auto-generation of shift openings, publishing of one or more shifts, selection of one or more shifts, generating feedback, predicting call-outs, predicting down times, predicting uptimes, forecasting, and the like.

Any machine learning model disclosed herein may be trained in a training phase using the data flow 1010 of FIG. 10 and deployed in a production phase using the data flow 1110 of FIG. 11. As shown in FIG. 10, training data 1012 may include inputs 1014 and labels 1018. The inputs 1014 may include at least shift data associated with a plurality of historical shifts (e.g., shifts that were previously opened and filled in the past), referred to as historical shift data 1016. The inputs 1014 may be from any applicable source including internal data sources, such as databases 115, public data sources, crowd sourced data, partner data sources (e.g., third parties associated with an institution), or the like or a combination thereof. The specific types of historical shift data 1016 included as inputs 1014 may vary between for machine learning model types, as described in more detail below. The labels 1018 may indicate known outcomes associated with each of the plurality of historical shifts and are related to the particular type of machine learning model being trained. The labels 1018 may be included for machine learning models generated based on supervised or semi-supervised training.

The training data 1012 and a training algorithm 1020 may be provided to a training component 1030 that may apply the training data 1012 to the training algorithm 1020 to generate a machine learning model 1040. For example, historical shift data 1016 for a predefined number of the historical shifts may be provided as input to the machine learning model 1040. The training algorithm 1020 determines predictions for the historical shifts based on the historical shift data 1016 that are provided as output of the machine learning model 1040. According to an implementation, the training component 1030 may be provided comparison results 1017 that compare the predictions for the historical shifts output by the machine learning model 1040 to the respective labels 1018 for the historical shifts representing the known outcome for the historical shifts. The comparison results 1017 may yield an error or loss that is used by the training component 1030 to update the machine learning model 1040 to improve the accuracy of the model. The training algorithm 1020 may utilize machine learning networks and/or models including, but not limited to Convolutional Neural Networks (CNN), Transformers, Recurrent Neural Networks (RNN), Seq2Seq, Long Short Term Memory (LSTM), Bayesian Inference, Generative Adversarial Networks (GAN), Deep Reinforcement Learning, statistical learning or the like or a combination thereof.

Once the machine learning model is sufficiently trained, the trained machine learning model 1140 may be deployed in a production phase 1120, as shown by the data flow 1110 in FIG. 11. The inputs 1130 received by the trained machine learning model 1140 may include current data associated with an upcoming shift (e.g., current shift data 1132). In some examples, an upcoming shift may be a shift that has yet to be opened. In other examples, an upcoming shift may be a shift for which opening has been initiated but the shift is not yet published, and/or filled. Accordingly, at least some aspects associated with the upcoming shift may have an unknown outcome. Based on the current shift data 1132 received as inputs 1130, the trained machine learning model 1140 may provide as output 1150 a prediction for the shift 1152. Additionally, the prediction for the shift 1152 may be provided as an input to one or more further decision processes 1160. The specific types of current shift data 1132 received as inputs 1130, the type of prediction for the shift 1152 provided as output 1150, and any further decision processes 1160 into which the output 1150 is provided may vary based on the type of the trained machine learning model.

Various types of machine learning models disclosed herein are discussed in turn below to provide specific but non-limiting examples of the training and deployment thereof in alignment with data flows 1010, 1110 presented in FIGS. 10 and 11. In these examples, the institution 105 may include a hospitality company (e.g., that owns a hotel brand with a plurality of properties) and one or more a combination of the above-described machine learning models may be trained and subsequently applied throughout the shift opening and publishing process for shifts that are to be filled at one or more properties.

As one example, a demand forecasting machine learning model may be trained and deployed to predict demand for upcoming shift, as discussed above with reference to FIG. 2B. In one non-limiting example, the demand forecasting machine learning model may be a supervised deep learning regression model with given input features and optimized hyperparameters, as disclosed herein. A related network may include residual connections to avoid vanishing gradients. For training the demand forecasting machine learning model, the specific types of historical shift data 1016 that are provided as inputs 1014 may include, but are not limited to: a shift type, a shift start time, a shift stop time, a location identifier, a number of rooms occupied, a year, a day of year, a day of week, a holiday, weather, a temperature, a hotel type, a hotel class, a region, a previous day's actual demand, a day of year (DOY) demand for a number of previous years, identifiers of a number of most likely shifters; regional weather data, regional transportation data, regional event data, crowdsourced data (e.g., related to labor and scheduling), and scheduling data associated with the given historical shift. The types of labels 1018 used to train the demand forecasting machine learning model may include a label for each of the plurality of historical shifts, the label indicating the actual demand associated with the respective historical shift.

Once trained, the demand forecasting machine learning model may be deployed in the production phase 1120 to predict demand for an upcoming shift. The specific types of current shift data 1132 that are provided as inputs 1130 to the trained demand forecasting machine learning model may be the same or similar types of data included as inputs 1014 during training except that the data is for a shift that has yet to be opened and/or published rather than for a historical or past shift. The prediction for the shift 1152 output 1150 by the trained demand forecasting machine learning model may be the predicted demand for the shift. In some implementations, the predicted demand for the shift may be used in a further decision process 1160 to automatically initiate an opening of the shift and/or to determine adjustments to the current shift data to meet the predicted demand as part of the shift opening process. Additionally, once the shift has been completed, an actual demand for the shift may be identified and received as feedback. The feedback may be used for modifying, adjusting, and/or retraining the model to increase the accuracy thereof.

As another example, a shift attractiveness machine learning model may be trained and deployed to predict a probability of an upcoming shift being accepted, as discussed above with reference to FIG. 2C. In one non-limiting example, the shift attractiveness machine learning model may be a supervised deep learning classifier model with given input features and optimized hyperparameters. The error or loss may be a probability such as a categorical cross entropy. For training the shift attractiveness machine learning model, the specific types of historical shift data 1016 provided as inputs 1014 may include, but are not limited to: a shift type, a shift rate adder, a shift start time, a shift stop time, a type of job function or specialty associated with the shift, a location identifier, a date and time the shift was posted, a length of time between publishing and filling the shift, a year, a day of year, a day of week, a holiday, weather, a temperature, a hotel type, a hotel class, a region, a previous day's actual demand, a day of year (DOY) demand for a number of previous years, and identifiers of a number of most likely shifters. The types of labels 1018 used to train the shift attractiveness machine learning model may include a label for each of the plurality of historical shifts, the label being a binary response (e.g., yes or no) as to whether the respective historical shift was filled.

Once trained, the shift attractiveness machine learning model may be deployed in the production phase 1120 to predict a probability of an upcoming shift being accepted. The specific types of current shift data 1132 that are provided as inputs 1130 to the trained shift attractiveness machine learning model may be the same or similar types of data included as inputs 1014 during training except that the data is for a shift that has yet to be opened and/or published rather than for a historical or past shift. The prediction for the shift 1152 output 1150 by the trained shift attractiveness machine learning model may be the predicted probability of the upcoming shift being accepted. In some implementations, the predicted probability of the upcoming shift being accepted may be used in a further decision process to determine adjustments to shift data for automatic implementation or provision as suggestions to increase that probability prior to publishing of the upcoming shift. Additionally, once the shift has been filled or alternatively is not filled, an indication of the shift's status as filled or not filled may be received as feedback. The feedback may be used for modifying, adjusting, and/or retraining the model to increase the accuracy thereof.

As a further example, an adaptive pay machine learning model may be trained and deployed to predict a length of time between the publishing and filling (e.g., accepting) of an upcoming shift, as discussed above with reference to FIG. 2D. In one non-limiting example, the adaptive pay machine learning model may be a supervised deep learning regression model with given input features and optimized hyperparameters, as disclosed herein. For training the adaptive pay machine learning model, the specific types of historical shift data 1016 provided as the inputs 1014 may include, but are not limited to: a shift type, a shift rate adder, a shift start time, a shift stop time, a location identifier, a date and time the shift was posted, a length of time between publishing and filling the shift, a year, a day of year, a day of week, a holiday, weather, a temperature, a hotel type, a hotel class, a region, and identifiers of a number of most likely shifters. The types of labels 1018 used to train the adaptive pay machine learning model may include a label for each of the plurality of historical shifts, the label indicating a length of time between the publishing and filling (e.g., accepting) of the historical shifts. In some examples, feature selection may be utilized post-training to identify features most correlated with the time it takes to fill the shift.

Once trained, the adaptive pay machine learning model may be deployed in the production phase 1120 to predict a probability of an upcoming shift being accepted. The specific types of current shift data 1132 that are provided as inputs 1130 to the trained adaptive pay machine learning model may be the same or similar types of data included as inputs 1014 during training except that the data is for a shift that has yet to be opened and/or published rather than for a historical or past shift. In some examples, a real-time database such as a Kafka database may be used to monitor the inputs in real time or near real time. The prediction for the shift 1152 provided as output 1150 of the trained adaptive pay machine learning model may be the predicted probability of the upcoming shift being accepted. In some implementations, the predicted probability of the upcoming shift being accepted may be used in a further decision process 1160 to determine adjustments to the upcoming shift for automatic implementation or provision as suggestions to increase that probability prior to publishing of the upcoming shift. Additionally, once the shift has been accepted/filled or alternatively is not filled, an indication of the shift's status as filled or not filled may be received as feedback. The feedback may be used for modifying, adjusting, and/or retraining the model to increase the accuracy thereof.

As a further example, a shifter optimization machine learning model may be trained and deployed to predict a probability of a given shifter not showing up for a shift, as discussed above with reference to FIG. 2F. For training the shifter machine learning model, the specific types of historical shift data 1016 provided as the inputs 1014 may include, but are not limited to: a shift type, a shift rate, a shift start time, a shift stop time, a location identifier, a date and time the shift was posted, a length of time between publishing and filling the shift, a year, a day of year, a day of week, a holiday, weather, a temperature, a hotel type, a hotel class, a region, identifiers of a number of most likely shifters. The types of labels 1018 used to train the shifter optimization machine learning model may include a label for each of the plurality of historical shifts, the label indicating a binary response (e.g., yes or no) as to whether the shifter that accepted the historical shift did not show up for the historical shift.

Once trained, the shifter optimization machine learning model may be deployed in the production phase 1120 to predict a probability of a given shifter not showing up for a shift. The specific types of current shift data 1132 that are provided as inputs 1130 to the trained shifter optimization machine learning model may be the same or similar types of data included as inputs 1014 during training except that the data is for a shift that has yet to be opened and/or published rather than for a historical or past shift. The prediction for the shift 1152 provided as output 1150 of the trained shifter optimization machine learning model may be the predicted probability of a given shifter not showing up for the shift. In some implementations, the predicted probability of the given shifter not showing up for the shift may be used in a further decision process 1160 to refine the shifters (e.g., to yield the optimal shifters) to whom the shift is published. Additionally, once the shift has been published to the given shifter, an indication of whether the given shifter accepted the shift and if so, showed up and completed the shift may be received as feedback. The feedback may be used for modifying, adjusting, and/or retraining the model to increase the accuracy thereof.

As yet another example, a shift prioritization machine learning model may be trained and deployed to predict a probability that a given shifter accepts a shift, as discussed above with reference to FIG. 2G. For training the shift prioritization machine learning model, the specific types of historical shift data 1016 for a historical shift provided as the inputs 1014 may include, but are not limited to: a shift type, a shift rate, a shift start time, a shift stop time, a location identifier, a number of rooms occupied, a year, a day of year, a day of week, a holiday, weather, a temperature, a hotel type, a hotel class, a region, whether a given shifter was presented the shift, and identifiers of a number of most likely shifters. The types of labels 1018 used to train the shift prioritization machine learning model may a label for each of the plurality of historical shifts, the label indicating a binary response (e.g., yes or no) as to whether the given shifter accepted the historical shift.

Once trained, the shift prioritization machine learning model may be deployed in the production phase 1120 to predict a probability that a given shifter accepts a shift. The specific types of current shift data 1132 that are provided as inputs 1130 to the trained shift prioritization machine learning model may be the same or similar types of data included as inputs 1014 during training except that the data is for a shift that has yet to be opened and/or published rather than for a historical or past shift. The prediction for the shift 1152 provided as output 1150 of the trained shift prioritization machine learning model may be the predicted probability that a given shifter accepts a shift. In some implementations, the predicted probability that a given shifter accepts a shift may be used in a further decision process 1160 for use in ordering (e.g., prioritizing) the shift among other shifts when publishing the shift to given shifter's profile. Additionally, once the shift has been published to the given shifter, an indication of whether the given shifter interacts with (e.g., views) and accepts the shift may be received as feedback. The feedback may be used for modifying, adjusting, and/or retraining the model to increase the accuracy thereof.

The above-discussed examples are non-limiting, non-exhaustive examples of the types of machine learning models that may be implemented.

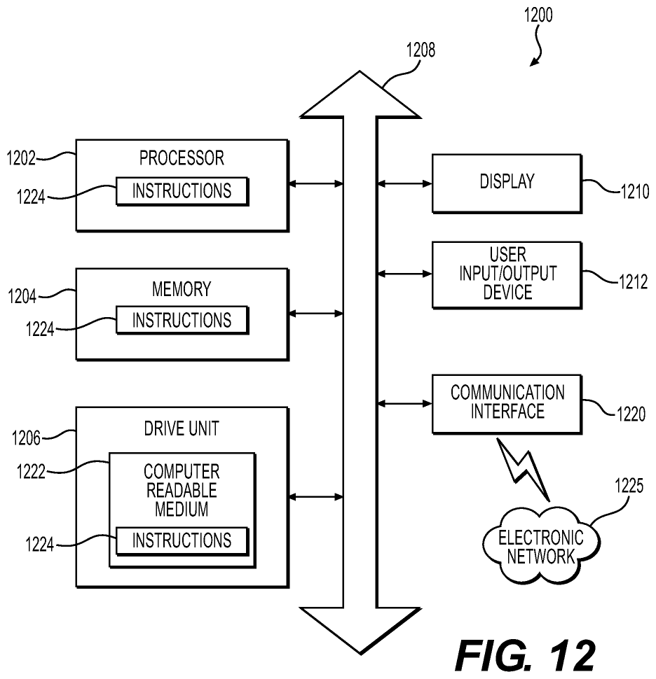

Any aspect of the techniques disclosed herein may be implemented in software, hardware, or firmware, as applicable. FIG. 12 is a simplified functional block diagram of a computer system 1200 that may be configured as a device for executing the methods described herein, according to exemplary embodiments of the present disclosure. FIG. 12 is a simplified functional block diagram of a computer system that may be used for shift owner/shifter onboarding and profile generation, shift generation, shift completion, shift based system optimization, or the like, according to exemplary embodiments of the present disclosure. In various embodiments, any of the systems (e.g., computer system 1200) herein may be an assembly of hardware including, for example, a data communication interface 1220 for packet data communication. The computer system 1200 also may include a central processing unit (“CPU”), in the form of one or more processors 1202, for executing program instructions. The computer system 1200 may include an internal communication bus 1208, and a storage unit 1206 (such as ROM, HDD, SDD, etc.) that may store data on a computer readable medium 1222, although the computer system 1200 may receive programming and data via network communications. The computer system 1200 may also have a memory 1204 (such as RAM) storing instructions 1224 for executing techniques presented herein, although the instructions 1224 may be stored temporarily or permanently within other modules of computer system 1200 (e.g., processor 1202 and/or computer readable medium 1222). The computer system 1200 also may include input and output ports 1212 and/or a display 1210 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform. One or more components of the computer system 1200 may be connected via an electronic network 1225 which may be provide access to one or more cloud components.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the presently disclosed methods, devices, and systems are described with exemplary reference to transmitting data, it should be appreciated that the presently disclosed embodiments may be applicable to any environment, such as a desktop or laptop computer, a mobile device, a wearable device, a text-based platform, an audio-based platform, a video-based platform, an automobile communication system, a home communication system, etc. This may apply to devices such as holographic devices or any devices associated with web 3.0 or the spatial web, or the like. Also, the presently disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method comprising:
generating, for a shift owner, a shift owner profile having a plurality of first attributes;
generating, for a plurality of shifters, a plurality of shifter profiles, each having a plurality of second attributes;
receiving an indication to initiate an opening of a shift associated with the shift owner;
opening the shift, wherein at least a portion of shift data defining the shift is automatically generated based on the indication and one or more of the plurality of first attributes;
identifying, using a trained shifter optimization machine learning model, a subset of the plurality of shifter profiles to publish the shift to, the subset having respective one or more of the plurality of second attributes that at least partially match the shift data;
publishing the shift to the subset of the plurality of shifter profiles;
in response to receiving an acceptance of the shift from at least one shifter profile in the subset, allocating the shift to the shifter associated with the at least one shifter profile;
receiving feedback associated with the shift; and
modifying the trained shifter optimization machine learning model based on the feedback.

2. The method of claim 1, wherein identifying, using the trained shifter optimization machine learning model, the subset of the plurality of shifter profiles to publish the shift to comprises:
querying the plurality of shifter profiles, using the shift data, to identify an initial subset of the plurality of shifter profiles having the respective one or more of the plurality of second attributes that at least partially match the shift data; and
determining, using the trained shifter optimization machine learning model, a subsequent subset of optimal shifter profiles from the initial subset to publish the shift to.

3. The method of claim 2, wherein determining, using the trained shifter optimization machine learning model, the subsequent subset of optimal shifter profiles from the initial subset to publish the shift to comprises:
providing, for each of the initial subset of the plurality of shifter profiles, as inputs to the trained shifter optimization machine learning model, the shift data and information associated with the respective shifter profile;
receiving, as output from the trained shifter optimization machine learning model, a predicted probability that a shifter associated with the respective shifter profile will not appear for the shift based on the inputs; and
determining, based on a comparison of the predicted probability with predicted probabilities for each other shifter profile of the initial subset, whether the respective shifter profile is an optimal shifter profile.

4. The computer-implemented method of claim 1, wherein the subset of the plurality of shifter profiles are further identified using one or more of geo-awareness, geofencing, and location based services (LBS).

5. The method of claim 1, wherein opening the shift further comprises:
automatically determining one or more adjustments to the shift data; and
at least one of:
automatically adjusting the shift data corresponding to the one or more adjustments; or
providing the one or more adjustments as recommendations to the shift owner profile to prompt the shift owner to implement the one or more adjustments.

6. The method of claim 5, further comprising:
providing at least a subset of the shift data as inputs to a trained demand forecasting machine learning model;
receiving a predicted demand for the shift as output from the trained demand forecasting machine learning model; and
determining, based on the predicted demand, the one or more adjustments to the shift data to meet the predicted demand.

7. The method of claim 5, further comprising:
providing at least a subset of the shift data as inputs to a trained shift attractiveness machine learning model;
receiving a predicted probability that the shift will be accepted as output from the trained shift attractiveness machine learning model; and
determining the one or more adjustments to the shift data to increase the predicted probability that the shift will be accepted.

8. The method of claim 7, wherein the predicted probability that the shift will be accepted is displayed as a predicted shift attractiveness score, and when the one or more adjustments are provided as recommendations to the shift owner profile, the recommendations include an updated shift attractiveness score to reflect a predicted probability that the shift will be accepted if the respective one or more adjustments are made to the shift data.

9. The method of claim 5, further comprising:
providing at least a subset of the shift data as inputs to a trained adaptive pay machine learning model;
receiving a predicted length of time between publishing of the shift and acceptance of the shift as output from the trained shift adaptive pay machine learning model; and
determining, based on the predicted length of time, the one or more adjustments to the shift data, the one or more adjustments being associated with a pay rate.

10. The computer-implemented method of claim 1, wherein publishing the shift to the subset of the plurality of shifter profiles comprises:
providing, for each of the subset of the plurality of shifter profiles, at least a subset of the shift data and information associated with the respective shifter profile as inputs to a trained shift prioritization machine learning model;
receiving a predicted probability that the shifter associated with the respective shifter profile accepts the shift as output from the trained shift prioritization machine learning model; and
determining, based on the predicted probability, an order in which to present the shift for display among one or more additional shifts published to the respective shifter profile.

11. The computer-implemented method of claim 1, wherein receiving the indication to open the shift associated with the shift owner comprises at least one of:
detecting an actuation by the shift owner to open the shift;
receiving an indication to open the shift based on a predicted demand associated with the shift;
detecting that a previous shifter to which the shift was allocated subsequently declined the shift; and
detecting a number of requests for the shift from the plurality of shifter profiles is above a predefined threshold.

12. The computer-implemented method of claim 1, wherein the shift is one of a plurality of shifts being opened within a predefined time frame, and the subset of the plurality of shifter profiles identified to publish the shift to are further identified in view of the plurality of shifts.

13. The computer-implemented method of claim 1, wherein receiving feedback associated with the shift comprises receiving one or more of an actual demand associated with the shift, a length of time between publishing and accepting of the shift, whether the shift was accepted or not by each shifter associated with a shifter profile within the subset, whether the shift was subsequently declined and re-allocated, or whether the shifter appeared for the shift.

14. A system comprising:
a processor; and
a memory coupled to the processor and storing instructions that, when executed by the processor, cause the system to:
generate, for a shift owner, a shift owner profile having a plurality of first attributes;
generate, for a plurality of shifters, a plurality of shifter profiles, each having a plurality of second attributes;
receive an indication to initiate an opening of a shift associated with the shift owner;
open the shift, wherein at least a portion of shift data defining the shift is automatically generated based on the indication and one or more of the plurality of first attributes;
identify, using a trained shifter optimization machine learning model, a subset of the plurality of shifter profiles to publish the shift to, the subset having respective one or more of the plurality of second attributes that at least partially match the shift data;
publish the shift to the subset of the plurality of shifter profiles;
in response to receiving an acceptance of the shift from at least one shifter profile in the subset, allocate the shift to the shifter associated with the at least one shifter profile;
receive feedback associated with the shift; and
modify the trained shifter optimization machine learning model based on the feedback.

15. The system of claim 14, wherein the shift owner and shifter are associated with an institution, the system is communicatively coupled to one or more databases storing institution data, and generation of the shift owner profile and the plurality of shifter profiles includes automatically retrieving portions of the institution data associated with the shift owner and the shifter to automatically generate the shift owner profile and the plurality of shifter profiles.

16. The system of claim 14, wherein the plurality of first attributes comprise one or more of a shift owner information, a shift owner applicable location, a shift owner preference, a preferred shifter, shift type specific content, a graphical user interface (GUI) preference, or a shift owner historical information.

17. The system of claim 14, wherein the plurality of second attributes comprise one or more of a shifter information, shifter qualifications, shifter position, shifter job title, shifter applicable location, shift preferences, hours, distance from key locations, co-worker preferences, manager preferences, preferred shift owner, shift type preferences, or graphical user interface (GUI) arrangement preferences.

18. The system of claim 14, wherein to identify, using the trained shifter optimization machine learning model, the subset of the plurality of shifter profiles to publish the shift to, the system is caused to:
query the plurality of shifter profiles, using the shift data, to identify an initial subset of the plurality of shifter profiles having the respective one or more of the plurality of second attributes that at least partially match the shift data; and
determining, using the trained shifter optimization machine learning model, a subsequent subset of optimal shifter profiles from the initial subset to publish the shift to.

19. The system of claim 14, wherein to open the shift, the system is further caused to deploy one or more additional trained machine learning models to optimize the shift data, and the feedback received may be further used to modify the one or more additional trained machine learning models.

20. Non-transitory computer readable media storing instructions that, when executed by a processor, cause operations to be performed, the operations including:
generating, for a shift owner, a shift owner profile having a plurality of first attributes;
generating, for a plurality of shifters, a plurality of shifter profiles, each having a plurality of second attributes;
receiving an indication to initiate an opening of a shift associated with the shift owner;
opening the shift, wherein at least a portion of shift data defining the shift is automatically generated based on the indication and one or more of the plurality of first attributes;
identifying, using a trained shifter optimization machine learning model, a subset of the plurality of shifter profiles to publish the shift to, the subset having respective one or more of the plurality of second attributes that at least partially match the shift data;
publishing the shift to the subset of the plurality of shifter profiles;
in response to receiving an acceptance of the shift from at least one shifter profile in the subset, allocating the shift to the shifter associated with the at least one shifter profile;
receiving feedback associated with the shift; and
modifying the trained shifter optimization machine learning model based on the feedback.
